(19) United States
(12) Patent Application Publication
(10) Pub. No.: US 2016/0191912 A1
(43) Pub. Date: Jun. 30, 2016

(54) HOME OCCUPANCY SIMULATION MODE SELECTION AND IMPLEMENTATION

(71) Applicant: EchoStar Technologies L.L.C., Englewood, CO (US)

(72) Inventors: Mark Wayne Lea, Kennesaw, GA (US); George Horkan Smith, Atlanta, GA (US)

(73) Assignee: EchoStar Technologies L.L.C., Englewood, CO (US)

(21) Appl. No.: 14/981,501

(22) Filed: Dec. 28, 2015

Related U.S. Application Data
(60) Provisional application No. 62/098,891, filed on Dec. 31, 2014.

(51) Int. Cl. H04N 17/00; H04N 21/418; H04N 7/10; H04N 21/41; H04L 12/28; H04N 21/436

(52) U.S. Cl. CPC H04N 17/004; H04L 12/2816; H04N 21/43615; H04N 7/106; H04N 21/4131; H04N 21/4183

(57) ABSTRACT

Enabling an end-user to configure or customize a home occupancy simulation mode, which is implemented by a home automation system, via one or more user interfaces, some of which might normally be used to access satellite television-related programming and services.

### CROSS-REFERENCE TO RELATED APPLICATIONS

This application claims the benefit of and priority to U.S. Provisional Application No. 62/098,891, filed Dec. 31, 2014, which is hereby incorporated by reference in its entirety for all purposes.

### BACKGROUND

Home automation systems are becoming increasingly prevalent, and may incorporate multiple smart devices and may allow end-users to control and/or view status information for those devices.

### SUMMARY

In an aspect, a method may include or comprise: detecting, by a television receiver, a command to activate a home occupancy simulation to control timing of activation and deactivation of at least one component that is located at a residence and that is communicatively coupled to the television receiver; selecting, by the television receiver, a particular home occupancy simulation based upon a setting that identifies the particular home automation simulation from among a plurality of home occupancy simulations; and activating, by the television receiver, the particular home occupancy simulation to control timing of activation and deactivation of the at least one component that is located at the residence and that is communicatively coupled to the television receiver.

In an aspect, a television receiver may include or comprise: at least one processor; and at least one memory element communicatively coupled with and readable by at least one processor and having stored therein processor-readable instructions that, when executed by the at least one processor, cause the at least one processor to: detect a command to activate a home occupancy simulation to control timing of activation and deactivation of at least one component that is located at a residence and that is communicatively coupled to the television receiver; select a particular home occupancy simulation based upon a setting that identifies the particular home automation simulation from among a plurality of home occupancy simulations; and activate the particular home occupancy simulation to control timing of activation and deactivation of the at least one component that is located at the residence and that is communicatively coupled to the television receiver.

In an aspect, a method for activating a home occupancy simulation may include or comprise: receiving, by a television receiver, a command to activate the home occupancy simulation, to control timing of activation and deactivation of at least one component that is located at a residence and that is communicatively coupled to the television receiver, from a mobile device over a network connection based upon user-selection of a particular control object of a mobile application installed to the mobile device; selecting, by the television receiver, a particular home occupancy simulation based upon a setting that identifies the particular home automation simulation from among a plurality of home occupancy simulations; activating, by the television receiver, the particular home occupancy simulation to control timing of activation and deactivation of the at least one component that is located at the residence and that is communicatively coupled to the television receiver; identifying another setting that specifies a particular degree of randomness to be injected into the timing of activation and deactivation of the at least one component; and injecting, based on the another setting, the particular degree of randomness into the timing of activation and deactivation of the at least one component.

Other aspects are possible.

### BRIEF DESCRIPTION OF THE DRAWINGS

FIG. 1A shows a first example method in accordance with the disclosure.

FIG. 1B shows a second example method in accordance with the disclosure.

FIG. 1C shows a third example method in accordance with the disclosure.

FIG. 1D shows a fourth example method in accordance with the disclosure.

FIG. 2 shows an example satellite system in accordance with the disclosure.

FIG. 3 shows an example block diagram of a television receiver.

FIG. 4 shows an example home automation system in accordance with the disclosure.

FIG. 5 shows first aspects of the example system of FIG. 4 in detail.

FIG. 6 shows second aspects of the example system of FIG. 4 in detail.

FIG. 7 shows third aspects of the example system of FIG. 4 in detail.

FIG. 8 shows an example computing system or device.

### DETAILED DESCRIPTION

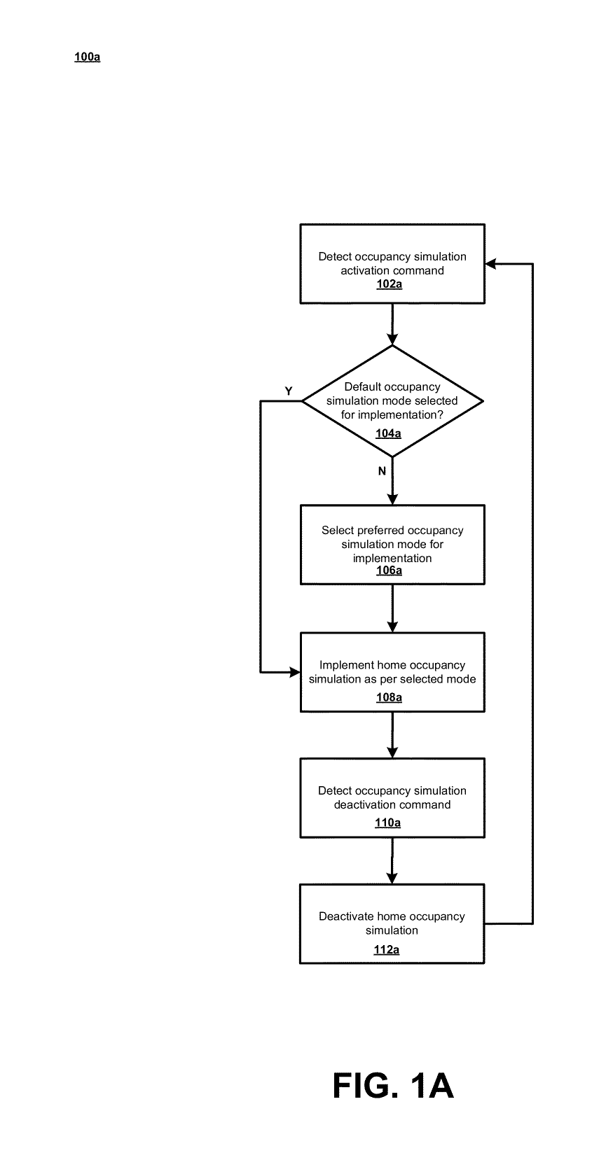

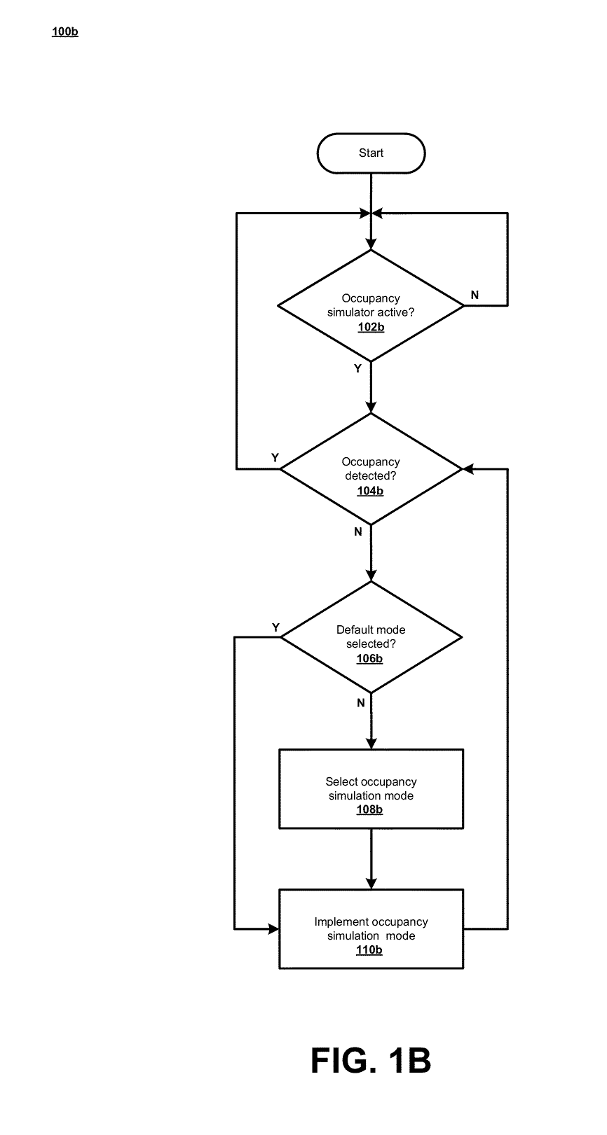

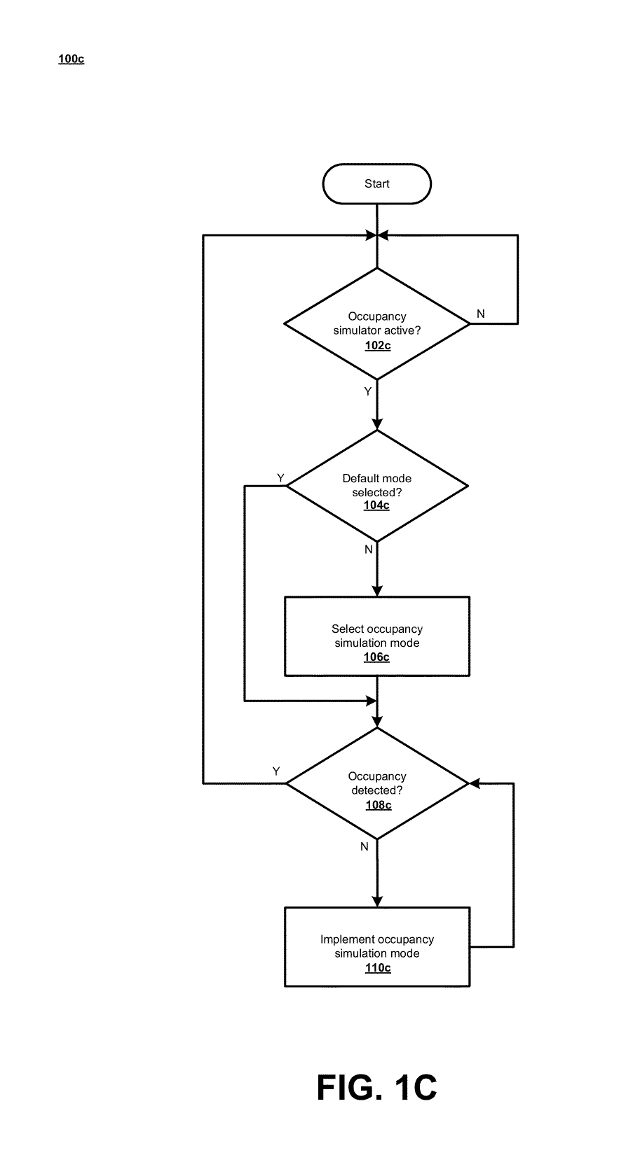

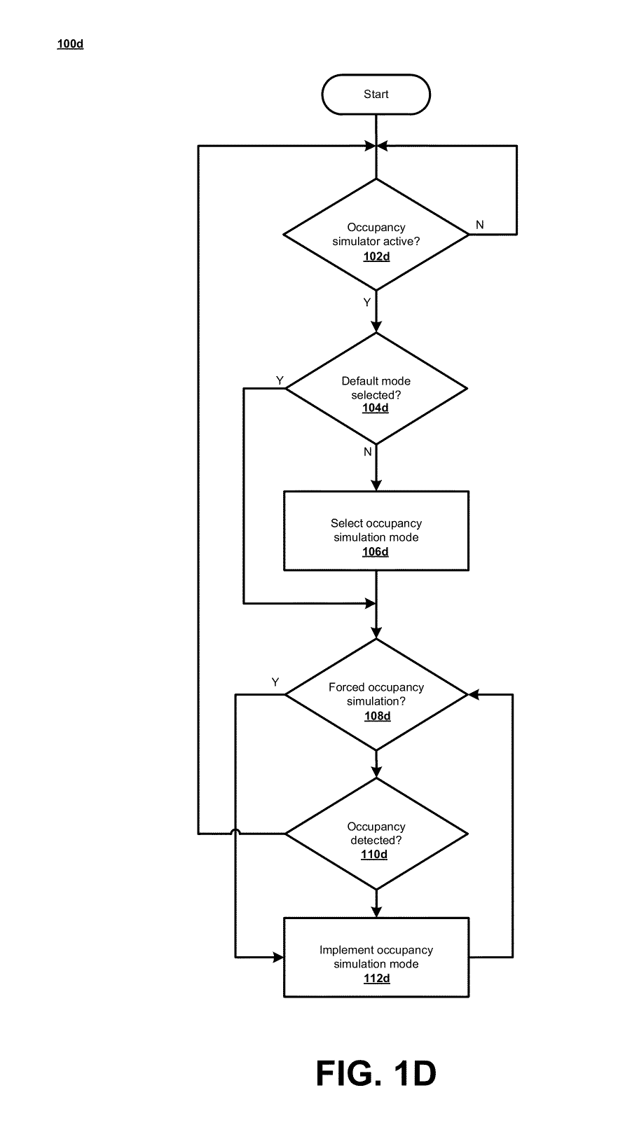

The present disclosure is directed to or towards systems and methods for enabling an end-user to configure or customize a home occupancy simulation mode, such as may be implemented by a home automation system. It is contemplated that this may be performed via one or more user interfaces, some of which might normally be used to access satellite television-related programming and services. Advantageously, such an implementation may serve to entice new customers to subscribe to home automation services as offered by a particular satellite television provider, together or in tandem with typical or conventional satellite television programming related services, as well as provide an incentive for existing customers to maintain their loyalty and/or relationship with the satellite television provider. Although not so limited, an appreciation of the various aspects of the present disclosure may be gained from the following discussion in connection with the drawings. For instance, referring now to FIG. 1A, an example method 100a is shown in accordance with the principles of the present disclosure.

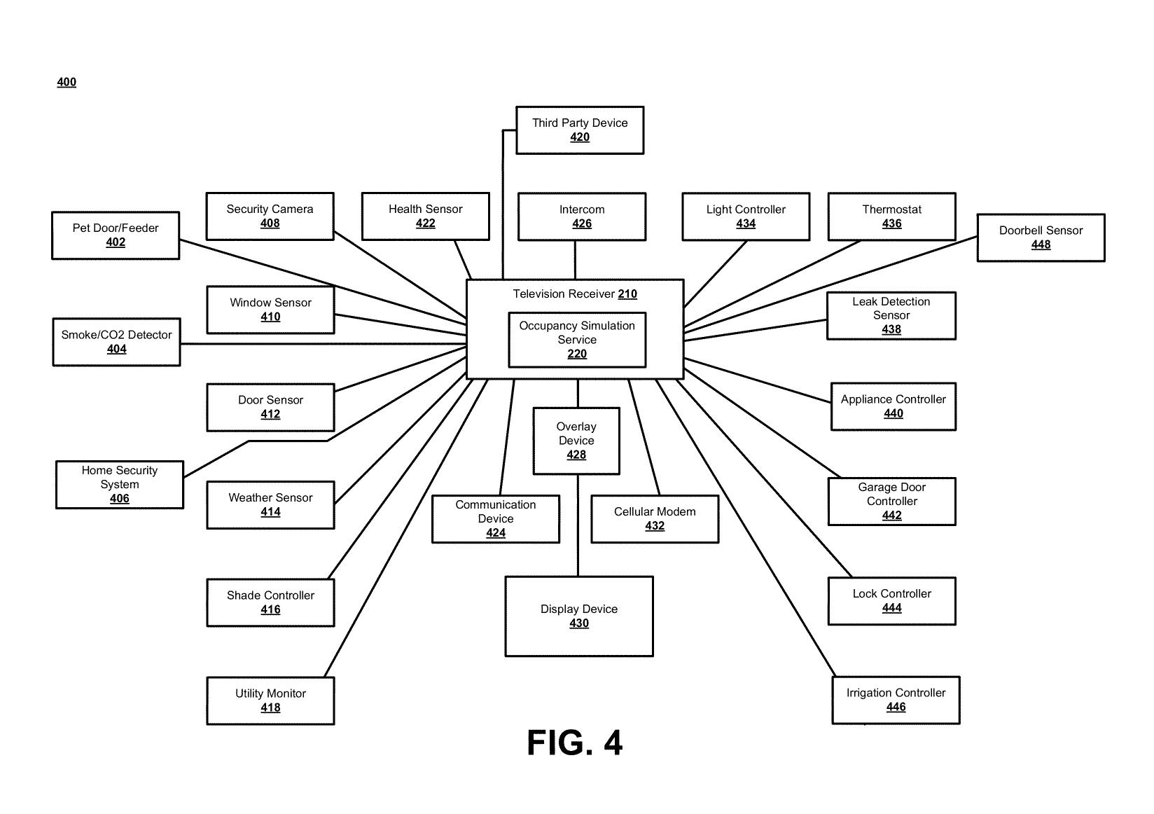

At step 102a, a television receiver that is incorporated into a home automation system as a home automation gateway device or the like may receive or detect a command to activate a home occupancy simulation routine. In this example, the television receiver may be communicatively coupled to a variety of home automation devices or components each positioned to a particular location of a residence. An example of such an implementation is discussed in detail below in connection with at least FIG. 4.

At step 104a, the television receiver may make a determination as to whether a “default” occupancy simulation mode has been pre-selected for implementation. For instance, the television receiver may determine whether a particular “bit” or “flag” or other type of setting is set, that which identifies or specifies the default occupancy simulation mode as pre-selected or active or engaged or the like. Upon an affirmative determination at step 104a, process flow may branch to step 108a. Otherwise, process flow may branch to step 106a. At step 106a, the television receiver may select a particular occupancy simulation mode for implementation as per a particular bit or flag or other type of setting that is set, that which identifies or specifies the particular occupancy simulation mode as pre-selected or active or engaged or the like.

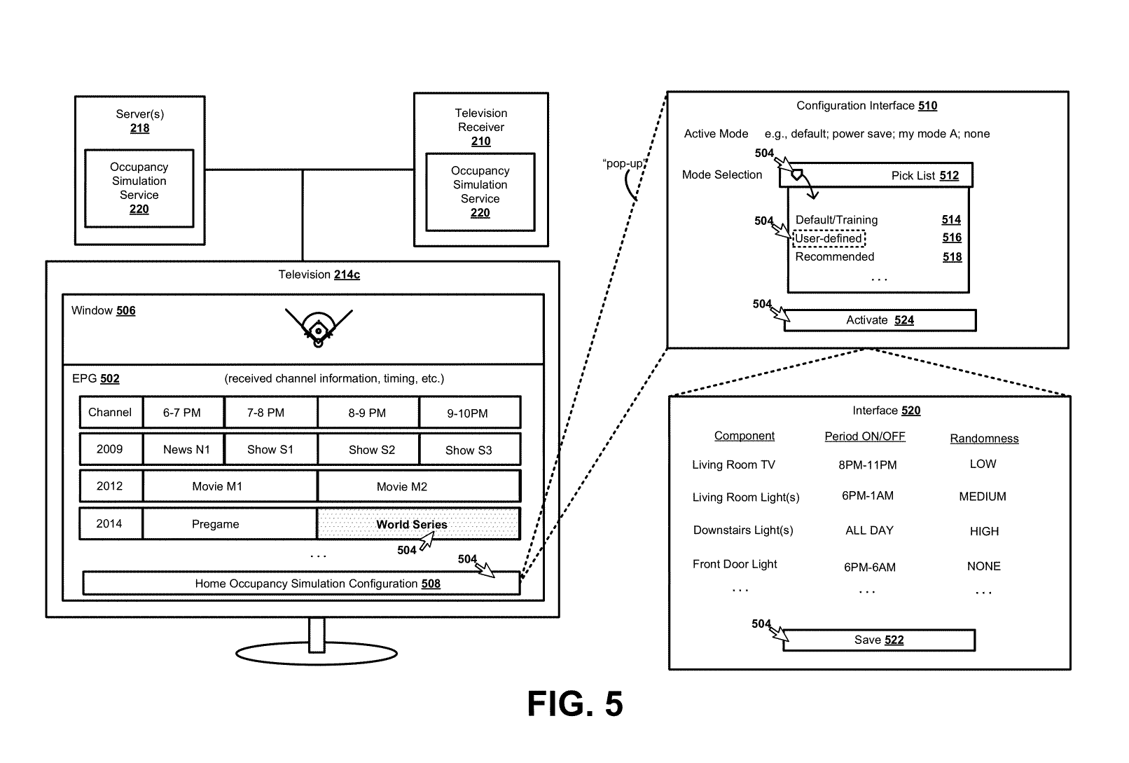

At step 108a, the television receiver may implement a particular home occupancy simulation routine in accordance with the principles of the present disclosure. For instance, in the event that step 108a is accessed directly from step 104a, the television receiver may access the above-mentioned default home occupancy simulation routine, and then implement the same. It is contemplated that such a home occupancy simulation routine may include or comprise instructions for timed activation/deactivation, possibly in tandem with a particular degree of randomness, of particular home automation devices or components based upon what the home automation system and/or television receiver has learned or observed over time. An example of a default occupancy simulation mode is discussed in detail below in connection with FIGS. 5-7.

In the event that step 108a is accessed directly from step 106a, the television receiver may access the above-mentioned preferred home occupancy simulation routine, and then implement the same. It is contemplated that such a home occupancy simulation routine may include or comprise instructions for timed activation/deactivation, possibly in tandem with a particular degree of randomness, of particular home automation devices or components based upon explicit user input or definitions. An example of a preferred occupancy simulation mode is discussed in detail below in connection with FIGS. 5-7.

Process flow may then proceed to step 110a, and then to step 112a, whereby the television receiver may receive or detect a particular command and then deactivate home occupancy simulation. It is contemplated that the timing of such deactivation (and activation) may be built-in to any particular home occupancy simulation routine, or based upon a manual input or command, as discussed in further detail throughout.

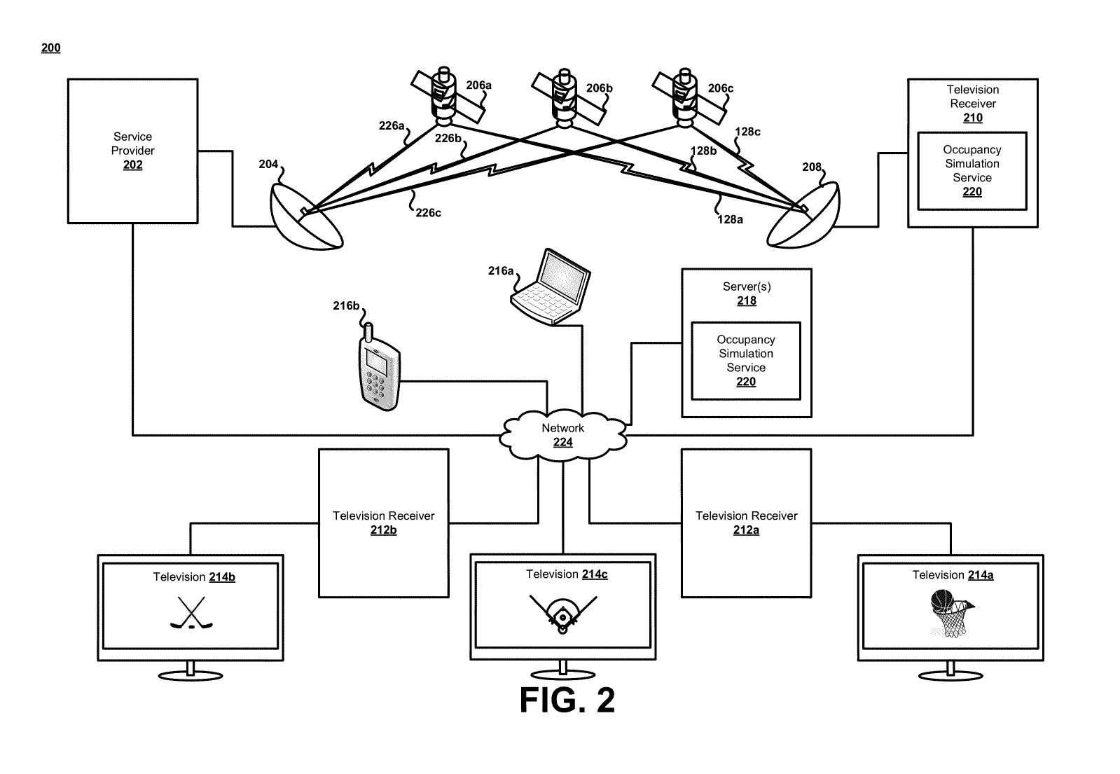

Other examples are possible as well. For instance, FIG. 1B shows a method 100b, FIG. 1C shows a method 100c, and FIG. 1D shows a method 100d, each of which may be understood to be a variant or modification or extension of the features or aspects of the method 100a of FIG. 1A. For example, as shown by steps 102b-110b in FIG. 1B, as shown by steps 102c-110c in FIG. 1C, and as shown by steps 102d-112d in FIG. 1D, a default mode selection aspect is contemplated whereby an option is provided or enabled to enter a default occupancy simulation mode upon satisfaction of one or more criterion, including in the absence of explicit user-input to select a particular occupancy simulation mode. Additionally, as shown by steps 102d-112d in FIG. 1D, a forced occupancy simulation aspect is contemplated whereby an occupancy simulation mode is activated or implemented regardless of whether occupancy is detected by the system or not. Further scenarios and/or beneficial aspects associated with enabling an end-user to configure or customize a home occupancy simulation mode are described in detail below in connection with FIGS. 2-8.

For instance, referring now to FIG. 2, an example satellite television distribution system 200 is shown in accordance with the present disclosure. For brevity, the system 200 is depicted in a simplified form, and may include more or fewer systems, devices, networks, and/or other components as desired. Further, number and type of features or elements incorporated within the system 200 may or may not be implementation-specific, and at least some of the aspects of the system 200 may be similar to a cable television distribution system, an IPTV (Internet Protocol Television) content distribution system, and/or any other type of content distribution system.

The example system 200 may include a service provider 202, a satellite uplink 204, a plurality of satellites 206a-c, a satellite dish 208, a PTR (Primary Television Receiver) 210, a plurality of STRs (Secondary Television Receivers) 212a-b, a plurality of televisions 214a-c, a plurality of computing devices 216a-b, and at least one server 218 that may in general be associated with or operated or implemented by the service provider 202. Additionally, the PTR 210 and the server 218 may include or otherwise exhibit an OSS (Occupancy Simulation Service) module 220. In general, and as discussed in further detail below, the OSS module 220 may be configured and/or arranged to enable an end-user to customize or configure various home automation-related features or functionality via one or more interfaces that might normally or typically be used to access satellite television-related programming and services.

The system 200 may further include at least one network 224 that establishes a bidirectional communication path for data transfer between and among each respective element of the system 200, outside or separate from the unidirectional satellite signaling path. The network 224 is intended to represent any number of terrestrial and/or non-terrestrial network features or elements. For example, the network 224 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular communications network, or any other type of communication network configured such that data may be transferred between and among elements of the system 200.

The PTR 210, and the STRs 212a-b, as described throughout may generally be any type of television receiver, television converter, etc., such as a STB for example. In another example, the PTR 210, and the STRs 212a-b, may exhibit functionality integrated as part of or into a television, a DVR (Digital Video Recorder), a computer such as a tablet computing device, or any other computing system or device, as well as variations thereof. Further, the PTR 210 and the network 224, together with the STRs 212a-b and televisions 214a-c, and possibly the computing devices 216a-b, may each be incorporated within or form at least a portion of a particular home computing network. Further, the PTR 210 may be configured so as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection), etc. Other examples are possible. For example, one or more of the various elements or components of the example system 200 may be configured to communicate in accordance with the MoCA® (Multimedia over Coax Alliance) home entertainment networking standard. Still other examples are possible.

In practice, the satellites 206a-c may each be configured to receive uplink signals 226a-c from the satellite uplink 204. In this example, each the uplink signals 226a-c may contain one or more transponder streams of particular data or content, such as one or more particular television channels, as supplied by the service provider 202. For example, each of the respective uplink signals 226a-c may contain various media or media content such as encoded HD (High Definition) television channels, SD (Standard Definition) television channels, on-demand programming, programming information, and/or any other content in the form of at least one transponder stream, and in accordance with an allotted carrier frequency and bandwidth. In this example, different media content may be carried using different ones of the satellites 206a-c.

Further, different media content may be carried using different transponders of a particular satellite (e.g., satellite 206a); thus, such media content may be transmitted at different frequencies and/or different frequency ranges. For example, a first and second television channel may be carried on a first carrier frequency over a first transponder of satellite 206a, and a third, fourth, and fifth television channel may be carried on second carrier frequency over a first transponder of satellite 206b, or, the third, fourth, and fifth television channel may be carried on a second carrier frequency over a second transponder of satellite 206a, etc. Each of these television channels may be scrambled such that unauthorized persons are prevented from accessing the television channels.

The satellites 206a-c may further be configured to relay the uplink signals 226a-c to the satellite dish 208 as downlink signals 228a-c. Similar to the uplink signals 226a-c, each of the downlink signals 228a-c may contain one or more transponder streams of particular data or content, such as various encoded and/or at least partially electronically scrambled television channels, on-demand programming, etc., in accordance with an allotted carrier frequency and bandwidth. The downlink signals 228a-c, however, may not necessarily contain the same or similar content as a corresponding one of the uplink signals 226a-c. For example, the uplink signal 226a may include a first transponder stream containing at least a first group or grouping of television channels, and the downlink signal 228a may include a second transponder stream containing at least a second, different group or grouping of television channels. In other examples, the first and second group of television channels may have one or more television channels in common. In sum, there may be varying degrees of correlation between the uplink signals 226a-c and the downlink signals 228a-c, both in terms of content and underlying characteristics.

Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, ESPN®, etc. Further, the term “channel,” may, in some contexts, carry a different meaning from or than its normal, plain language meaning. For example, the term “channel” may denote a particular carrier frequency or sub-band which can be tuned to by a particular tuner of a television receiver. In other contexts though, the term “channel” may refer to a single program/content service such as HBO®.

Additionally, a single satellite may typically have multiple transponders (e.g., 32 transponders) each one broadcasting a channel or frequency band of about 24-27 MHz in a broader frequency or polarity band of about 500 MHz. Thus, a frequency band of about 500 MHz may contain numerous sub-bands or channels of about 24-27 MHz, and each channel in turn may carry a combined stream of digital data comprising a number of content services. For example, a particular hypothetical transponder may carry HBO®, CBS®, ESPN®, plus several other channels, while another particular hypothetical transponder may itself carry 3, 4, 5, 6, etc., different channels depending on the bandwidth of the particular transponder and the amount of that bandwidth occupied by any particular channel or service on that transponder stream. Further, in many instances a single satellite may broadcast two orthogonal polarity bands of about 500 MHz. For example, a first polarity band of about 500 MHz broadcast by a particular satellite may be left-hand circular polarized, and a second polarity band of about 500 MHz may be right-hand circular polarized. Other examples are possible.

Continuing with the example scenario, the satellite dish 208 may be provided for use to receive television channels (e.g., on a subscription basis) provided by the service provider 202, satellite uplink 204, and/or satellites 206a-c. For example, the satellite dish 208 may be configured to receive particular transponder streams, or downlink signals 228a-c, from one or more of the satellites 206a-c. Based on the characteristics of the PTR 210 and/or satellite dish 208, however, it may only be possible to capture transponder streams from a limited number of transponders concurrently. For example, a particular tuner of the PTR 210 may be configured to tune to a single transponder stream from a transponder of a single satellite at a time.

Additionally, the PTR 210, which is communicatively coupled to the satellite dish 208, may subsequently select via tuner, decode, and relay particular transponder streams to the television 214c for display thereon. For example, the satellite dish 208 and the PTR 210 may, respectively, be configured to receive, decode, and relay at least one premium HD-formatted television channel to the television 214c. Programming or content associated with the HD channel may generally be presented live, or from a recording as previously stored on, by, or at the PTR 210. Here, the HD channel may be output to the television 214c in accordance with the HDMI/HDCP content protection technologies. Other examples are possible, however.

Further, the PTR 210 may select (via a tuner), decode, and relay particular transponder streams to one or both of the STRs 212a-b, which may in turn relay particular transponder streams to a corresponding one of the televisions 214a-b for display thereon. For example, the satellite dish 208 and the PTR 210 may, respectively, be configured to receive, decode, and relay at least one television channel to the television 214a by way of the STR 212a. Similar to the above-example, the television channel may generally be presented live, or from a recording as previously stored on the PTR 210, and may be output to the television 214a by way of the STR 212a in accordance with a particular content protection technology and/or networking standard. Still further, the satellite dish 208 and the PTR 210 may, respectively, be configured to receive, decode, and relay at least one premium television channel to one or each of the computing devices 216a-c. Similar to the above-examples, the television channel may generally be presented live, or from a recording as previously stored on the PTR 210, and may be output to one or both of the computing devices 216a-c in accordance with a particular content protection technology and/or networking standard.

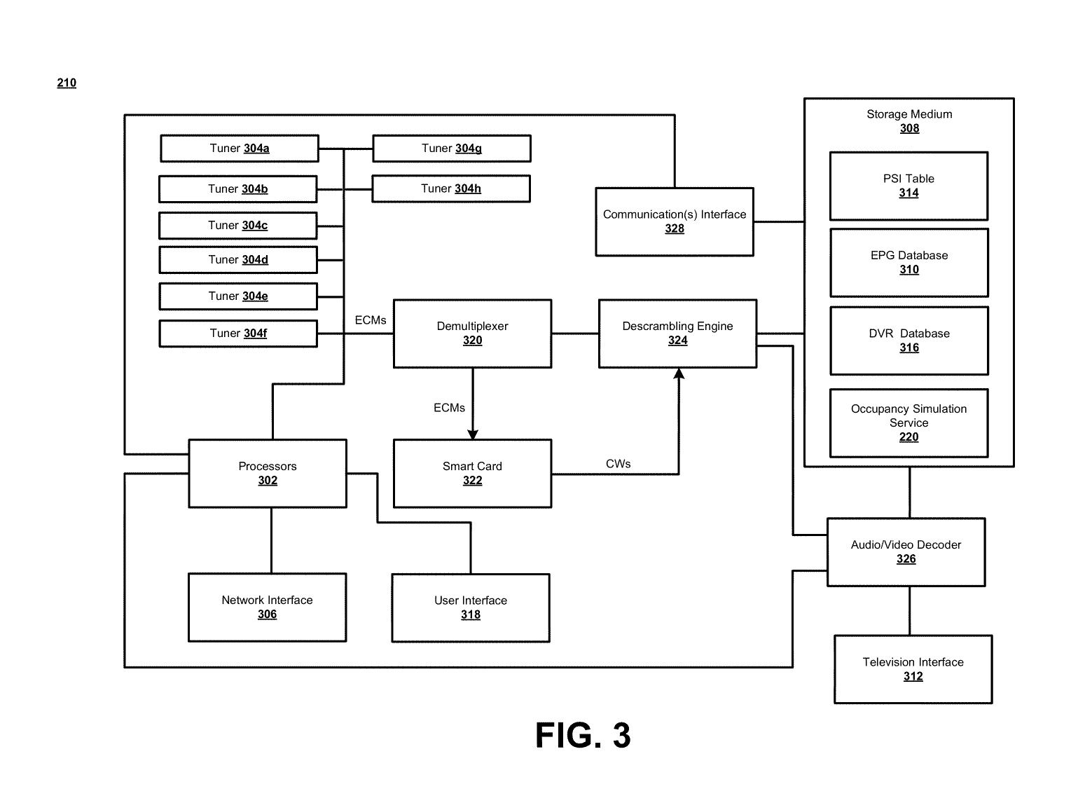

Referring now to FIG. 3, an example block diagram of the PTR 210 of FIG. 2 is shown in accordance with the disclosure. In some examples, the STRs 212a-b may be configured in a manner similar to that of the PTR 210. In some examples, the STRs 212a-b may be configured and arranged to exhibit a reduced functionality as compared to the PTR 210, and may depend, at least to a certain degree, on the PTR 210 to implement certain features or functionality. The STRs 212a-b in such an example may each be referred to as a “thin client.”

The PTR 210 may include one or more processors 302, a plurality of tuners 304a-h, at least one network interface 306, at least one non-transitory computer-readable storage medium 308, at least one EPG database 310, at least one television interface 312, at least one PSI (Program Specific Information) table 314, at least one DVR database 316, at least one user interface 318, at least one demultiplexer 320, at least one smart card 322, at least one descrambling engine 324, at least one decoder 326, and at least one communication interface 328. In other examples, fewer or greater numbers of components may be present. Further, functionality of one or more components may be combined; for example, functions of the descrambling engine 324 may be performed by the processors 302. Still further, functionality of components may be distributed among additional components, and possibly additional systems such as, for example, in a cloud-computing implementation.

The processors 302 may include one or more specialized and/or general-purpose processors configured to perform processes such as tuning to a particular channel, accessing and displaying EPG information, and/or receiving and processing input from a user. For example, the processors 302 may include one or more processors dedicated to decoding video signals from a particular format, such as according to a particular MPEG (Motion Picture Experts Group) standard, for output and display on a television, and for performing or at least facilitating decryption or descrambling.

The tuners 304a-h may be used to tune to television channels, such as television channels transmitted via satellites 206a-c. Each one of the tuners 304a-h may be capable of receiving and processing a single stream of data from a satellite transponder, or a cable RF channel, at a given time. As such, a single tuner may tune to a single transponder or, for a cable network, a single cable channel. Additionally, one tuner (e.g., tuner 304a) may be used to tune to a television channel on a first transponder stream for display using a television, while another tuner (e.g., tuner 304b) may be used to tune to a television channel on a second transponder for recording and viewing at some other time. If multiple television channels transmitted on the same transponder stream are desired, a particular tuner (e.g., tuner 304c) may be used to receive the signal containing the multiple television channels for presentation and/or recording of each of the respective multiple television channels, such as in a PTAT (Primetime Anytime) implementation for example. Although eight tuners are shown, the PTR 210 may include more or fewer tuners (e.g., three tuners, sixteen tuners, etc.), and the features of the disclosure may be implemented similarly and scale according to the number of tuners of the PTR 210.

The network interface 306 may be used to communicate via alternate communication channel(s) with a service provider. For example, the primary communication channel between the service provider 202 of FIG. 2 and the PTR 210 may be via satellites 206a-c, which may be unidirectional to the PTR 210, and another communication channel between the service provider 202 and the PTR 210, which may be bidirectional, may be via the network 224. In general, various types of information may be transmitted and/or received via the network interface 306.

The storage medium 308 may represent a non-transitory computer-readable storage medium. The storage medium 308 may include memory and/or a hard drive. The storage medium 308 may be used to store information received from one or more satellites and/or information received via the network interface 306. For example, the storage medium 308 may store information related to the EPG database 310, the PSI table 314, and/or the DVR database 316, among other elements or features, such as the OSS module 220 mentioned above. Recorded television programs may be stored using the storage medium 308 and ultimately accessed therefrom.

The EPG database 310 may store information related to television channels and the timing of programs appearing on such television channels. Information from the EPG database 310 may be used to inform users of what television channels or programs are available, popular and/or provide recommendations. Information from the EPG database 310 may be used to generate a visual interface displayed by a television that allows a user to browse and select television channels and/or television programs for viewing and/or recording. Information used to populate the EPG database 310 may be received via the network interface 306 and/or via satellites 206a-c of FIG. 2. For example, updates to the EPG database 310 may be received periodically or at least intermittently via satellite. The EPG database 310 may serve as an interface for a user to control DVR functions of the PTR 210, and/or to enable viewing and/or recording of multiple television channels simultaneously.

The decoder 326 may convert encoded video and audio into a format suitable for output to a display device. For instance, the decoder 326 may receive MPEG video and audio from the storage medium 308, or the descrambling engine 324, to be output to a television. MPEG video and audio from the storage medium 308 may have been recorded to the DVR database 316 as part of a previously-recorded television program. The decoder 326 may convert the MPEG video into a format appropriate to be displayed by a television or other form of display device, and audio into a format appropriate to be output from speakers. The decoder 326 may be a single hardware element capable of decoding a finite number of television channels at a given time, such as in a time-division arrangement. In the example, eight television channels may be decoded concurrently or simultaneously.

The television interface 312 outputs a signal to a television, or another form of display device, in a proper format for display of video and play back of audio. As such, the television interface 312 may output one or more television channels, stored television programming from the storage medium 308, such as television programs from the DVR database 316 and/or information from the EPG database 310 for example, to a television for presentation.

The PSI table 314 may store information used by the PTR 210 to access various television channels. Information used to populate the PSI table 314 may be received via satellite, or cable, through the tuners 304a-h and/or may be received via the network interface 306 over the network 224 from the service provider 202 shown in FIG. 2. Information present in the PSI table 314 may be periodically or at least intermittently updated. Information that may be present in the PSI table 314 may include: television channel numbers, satellite identifiers, frequency identifiers, transponder identifiers, Entitlement Control Message (ECM) Packet Identifier (PIDs), one or more audio PIDs, and video PIDs. A second audio PID of a channel may correspond to a second audio program, such as in another language. In some examples, the PSI table 314 may be divided into a number of tables, such as a NIT (Network Information Table), a PAT (Program Association Table), and a PMT (Program Management Table).

Table 1 below provides a simplified example of the PSI table 314 for several television channels. It should be understood that in other examples, many more television channels may be represented in the PSI table 314. The PSI table 314 may be periodically or at least intermittently. As such, television channels may be reassigned to different satellites and/or transponders, and the PTR 210 may be able to handle this reassignment as long as the PSI table 314 is updated.

TABLE 1

| Channel | Satellite | Transponder | ECM PID | Audio PIDs | Video PID |
|---|---|---|---|---|---|
| 4 | 1 | 2 | 27 | 2001 | 1011 |
| 5 | 2 | 11 | 29 | 2002 | 1012 |
| 7 | 2 | 3 | 31 | 2003 | 1013 |
| 13 | 2 | 4 | 33 | 2003, 2004 | 1013 |

It should be understood that the values provided in Table 1 are for example purposes only. Actual values, including how satellites and transponders are identified, may vary. Additional information may also be stored in the PSI table 314. Video and/or audio for different television channels on different transponders may have the same PIDs. Such television channels may be differentiated based on which satellite and/or transponder to which a tuner is tuned.

DVR functionality of the PTR 210 may permit a television channel to be recorded for a period of time. The DVR database 316 may store timers that are used by the processors 302 to determine when a television channel should be tuned to and recorded to the DVR database 316 of storage medium 308. In some examples, a limited amount of space of the storage medium 308 may be devoted to the DVR database 316. Timers may be set by the service provider 202 and/or one or more users of the PTR 210. DVR functionality of the PTR 210 may be configured by a user to record particular television programs. The PSI table 314 may be used by the PTR 210 to determine the satellite, transponder, ECM PID, audio PID, and video PID.

The user interface 318 may include a remote control, physically separate from PTR 210, and/or one or more buttons on the PTR 210 that allows a user to interact with the PTR 210. The user interface 318 may be used to select a television channel for viewing, view information from the EPG database 310, and/or program a timer stored to the DVR database 316 wherein the timer may be used to control the DVR functionality of the PTR 210.

Referring back to the tuners 304a-h, television channels received via satellite may contain at least some encrypted or scrambled data. Packets of audio and video may be scrambled to prevent unauthorized users, such as nonsubscribers, from receiving television programming without paying the service provider 202. When one of the tuners 304a-h is receiving data from a particular transponder of a satellite, the transponder stream may be a series of data packets corresponding to multiple television channels. Each data packet may contain a PID, which in combination with the PSI table 314, can be determined to be associated with a particular television channel. Particular data packets, referred to as ECMs may be periodically transmitted. ECMs may be encrypted; the PTR 210 may use the smart card 322 to decrypt ECMs.

The smart card 322 may function as the CA (Controlled Access) which performs decryption of encryption data to obtain control words that are used to descramble video and/or audio of television channels. Decryption of an ECM may only be possible when the user (e.g., an individual who is associated with the PTR 210) has authorization to access the particular television channel associated with the ECM. When an ECM is received by the demultiplexer 320 and the ECM is determined to correspond to a television channel being stored and/or displayed, the ECM may be provided to the smart card 322 for decryption.

When the smart card 322 receives an encrypted ECM from the demultiplexer 320, the smart card 322 may decrypt the ECM to obtain some number of control words. In some examples, from each ECM received by the smart card 322, two control words are obtained. In some examples, when the smart card 322 receives an ECM, it compares the ECM to the previously received ECM. If the two ECMs match, the second ECM is not decrypted because the same control words would be obtained. In other examples, each ECM received by the smart card 322 is decrypted; however, if a second ECM matches a first ECM, the outputted control words will match; thus, effectively, the second ECM does not affect the control words output by the smart card 322. When an ECM is received by the smart card 322, it may take a period of time for the ECM to be decrypted to obtain the control words. As such, a period of time, such as about 0.2-0.5 seconds, may elapse before the control words indicated by the ECM can be obtained. The smart card 322 may be permanently part of the PTR 210 or may be configured to be inserted and removed from the PTR 210.

The demultiplexer 320 may be configured to filter data packets based on PIDs. For example, if a transponder data stream includes multiple television channels, data packets corresponding to a television channel that are not desired to be stored or displayed by the user may be ignored by the demultiplexer 320. As such, only data packets corresponding to the one or more television channels desired to be stored and/or displayed may be passed to either the descrambling engine 324 or the smart card 322; other data packets may be ignored. For each channel, a stream of video packets, a stream of audio packets and/or a stream of ECM packets may be present, each stream identified by a PID. In some examples, a common ECM stream may be used for multiple television channels. Additional data packets corresponding to other information, such as updates to the PSI table 314, may be appropriately routed by the demultiplexer 320.

The descrambling engine 324 may use the control words output by the smart card 322 in order to descramble video and/or audio corresponding to television channels for storage and/or presentation. Video and/or audio data contained in the transponder data stream received by the tuners 304a-h may be scrambled. The video and/or audio may be descrambled by the descrambling engine 324 using a particular control word. Which control word output by the smart card 322 to be used for successful descrambling may be indicated by a scramble control identifier present within the data packet containing the scrambled video or audio. Descrambled video and/or audio may be output by the descrambling engine 324 to the storage medium 308 for storage, such as part of the DVR database 316 for example, and/or to the decoder 326 for output to a television or other presentation equipment via the television interface 312.

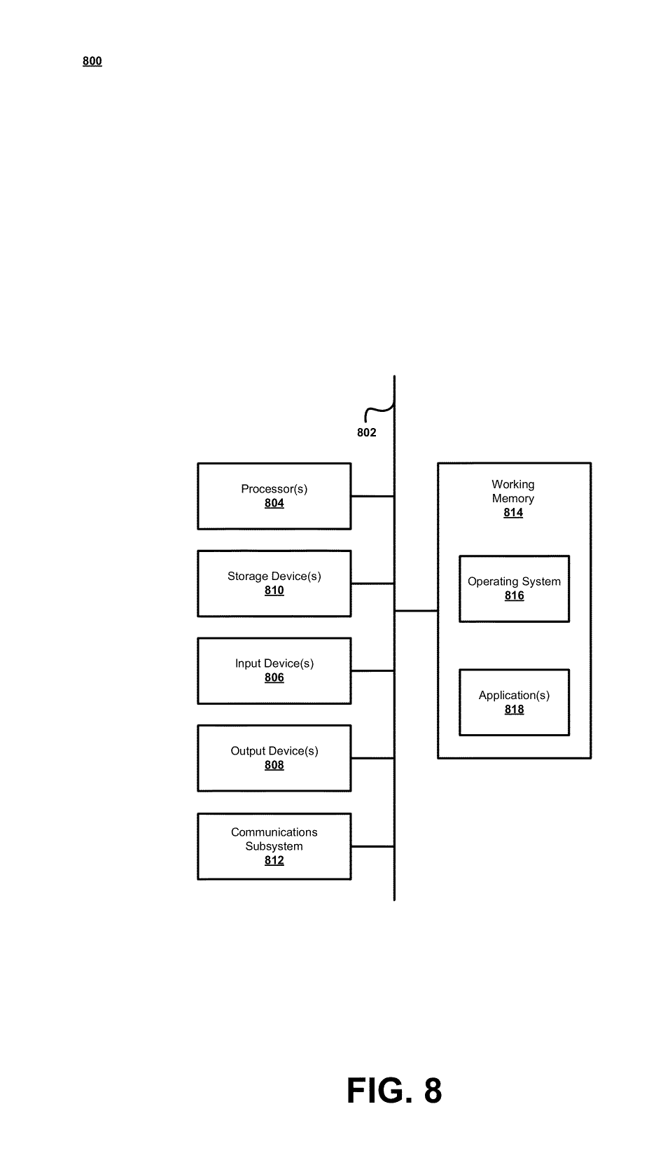

The communication interface 328 may be used by the PTR 210 to establish a communication link or connection between the PTR 210 and one or more of the computing systems and devices as shown in FIG. 2 and FIG. 4, discussed further below. It is contemplated that the communication interface 328 may take or exhibit any form as desired, and may be configured in a manner so as to be compatible with a like component or element incorporated within or to a particular one of the computing systems and devices as shown in FIG. 2 and FIG. 4, and further may be defined such that the communication link may be wired and/or or wireless. Example technologies consistent with the principles or aspects of the present disclosure may include, but are not limited to, Bluetooth®, WiFi, NFC (Near Field Communication), HomePlug®, and/or any other communication device or subsystem similar to that discussed below in connection with FIG. 8.

For brevity, the PTR 210 is depicted in a simplified form, and may generally include more or fewer elements or components as desired, including those configured and/or arranged for implementing various features for enabling an end-user to access home automation features or functionality directly from or via one or more interfaces that might normally be used to access satellite television-related programming and services, in accordance with the principles of the present disclosure. For example, the PTR 210 is shown in FIG. 3 to include an instance of the OSS module 220 as mentioned above in connection with FIG. 2. While shown stored to the storage medium 308 as executable instructions, the OSS module 220 could, wholly or at least partially, be stored to the processor(s) 302 of the PTR 210. Further, some routing between the various modules of PTR 210 has been illustrated. Such illustrations are for exemplary purposes only. The state of two modules not being directly or indirectly connected does not indicate the modules cannot communicate. Rather, connections between modules of the PTR 210 are intended only to indicate possible common data routing. It should be understood that the modules of the PTR 210 may be combined into a fewer number of modules or divided into a greater number of modules.

Additionally, although not explicitly shown in FIG. 3, the PTR 210 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Further, the PTR 210 may be configured to include any number of other various components or logical modules that are implemented in hardware, software, firmware, or any combination thereof, and such components or logical modules may or may not be implementation-specific.

Referring now to FIG. 4, an example home automation system 400 is shown in accordance with the present disclosure. In an example, the home automation system 400 may be hosted by the PTR 210 of FIG. 2, and thus the PTR 210 may be considered a home automation gateway device or system. An overlay device 428 is also shown in FIG. 4. In another example, the home automation system 400 may be hosted by the overlay device 428 of FIG. 4, and thus the overlay device 428 may be considered a home automation gateway device or system. Still other examples are possible. For instance, in some example, features or functionality of the overlay device 428 may be wholly or at least partially incorporated into the PTR 210 (and vice versa), so that the home automation system 400 may be considered to be hosted or managed or controlled by both PTR 210 and the overlay device 428. In this manner, the PTR 210, the overlay device 428, or any combination of functionality thereof, may be considered the “brain” or central feature or aspect of the example home automation system 400.

Accordingly, the PTR 210 and/or the overlay device 428 may be configured and/or arranged to communicate with multiple in-home or on-residence home automation-related systems and/or devices. Some examples of which include, but are not limited to: at least one pet door/feeder 402, at least one smoke/CO₂ detector 404, a home security system 406, at least one security camera 408, at least one window sensor 410, at least one door sensor 412, at least one weather sensor 414, at least one shade controller 416, at least one utility monitor 418, at least one third party device 420, at least one health sensor 422, at least one communication device 424, at least one intercom 426, at least one overlay device 428, at least one display device 430, at least one cellular modem 432, at least one light controller 434, at least one thermostat 436, at least one leak detection sensor 438, at least one appliance controller 440, at least one garage door controller 442, at least one lock controller 444, at least one irrigation controller 446, and at least one doorbell sensor 448. The home automation system 400 of FIG. 4 is just an example. Other examples are possible, as discussed further below.

It is contemplated that the each of the elements of FIG. 4 that the PTR 210 communicates with may use different communication standards. For example, one or more elements may use or otherwise leverage a ZigBee® communication protocol, while one or more other devices may communicate with the PTR 210 using a Z-Wave® communication protocol. As another example, one or more elements may use or otherwise leverage a WiFi communication protocol, while one or more other devices may communicate with the PTR 210 using a Bluetooth communication protocol. Any combination thereof is further contemplated, and other forms of wireless communication may be used by particular elements of FIG. 4 to enable communications to and from the PTR 210, such as any particular IEEE (Institute of Electrical and Electronics Engineers) standard or specification or protocol, such as the IEEE 802.11 technology for example. Wired communications are also envisioned, such as Ethernet or IEEE 802.3 compliant communications.

In some examples, a separate device may be connected with the PTR 210 to enable communication with the smart home automation systems or devices of FIG. 4. For instance, the communication device 424 as shown coupled with the PTR 210 may take the form of a dongle. In some examples, the communication device 424 may be configured to allow for Zigbee®, Z-Wave®, and/or other forms of wireless communication. In some examples, the communication device 424 may connect with the PTR 210 via a USB (Universal Serial Bus) port or via some other type of (e.g., wired) communication port. Accordingly, the communication device 424 may be powered by the PTR 210 or may be separately coupled with another different particular power source. In some examples, the PTR 210 may be enabled to communicate with a local wireless network and may use communication device in order to communicate with devices that use a ZigBee® communication protocol, Z-Wave® communication protocol, and/or some other wireless communication protocols.

In some examples, the communication device 424 may also serve to allow or enable additional components to be connected with the PTR 210. For instance, the communication device 424 may include additional audio/video inputs (e.g., HDMI), component, and/or composite inputs to allow for additional devices (e.g., Blu-Ray players) to be connected with the PTR 210. Such a connection may allow video comprising home automation information to be “overlaid” with television programming and/or EPG information, with all selected elements being simultaneously output for display by a particular presentation device. Whether home automation information is overlaid onto video on display may be triggered based on a press of a remote control button by an end-user.

Regardless of whether the PTR 210 uses the communication device 242 to communicate with any particular home automation device shown in FIG. 4 or other particular home automation device not explicitly shown in FIG. 4, the PTR 210 may be configured to output home automation information for presentation via the display device 430. It is contemplated that the display device 430 could correspond to any particular one of the mobile devices 216a-b and televisions 214a-c as shown in FIG. 2. Still other examples are possible. Such information may be presented simultaneously, concurrently, in tandem, etc., with any particular television programming received by the PTR 210 via any particular communication channel as discussed above. It is further contemplated that the PTR 210 may also, at any particular instant or given time, output only television programming or only home automation information based on preferences or commands or selections of particular controls within an interface of or by any particular end-user. Furthermore, an end-user may be able to provide input to the PTR 210 to control the home automation system 400, in its entirety as hosted by the PTR 210 or by the overlay device 428, as discussed further below.

In some examples, the overlay device 428 may be coupled with the PTR 210 to allow or enable home automation information to be presented via the display device 430. It is contemplated that the overlay device 428 may be configured and/or arranged to overlay information, such as home automation information, onto a signal that will ultimately enable the home automation information to be visually presented via the display device 430. In this example, the PTR 210 may receive, decode, descramble, decrypt, store, and/or output television programming. The PTR 210 may output a signal, such as in the form of an HDMI signal. Rather than being directly input to the display device 430, however, the output of the PTR 210 may be input to the overlay device 428. Here, the overlay device 428 may receive video and/or audio output from the PTR 210.

The overlay device 428 may add additional information to the video and/or audio signal received from the PTR 210 so as to modify or augment or even “piggyback” on the same. That video and/or audio signal may then be output by the overlay device 428 to the display device 430 for presentation thereon. In some examples, the overlay device 428 may include or exhibit an HDMI input/output, with the HDMI output being connected to the display device 430. While FIG. 4 shows lines illustrating communication between the PTR 210 and other various devices, it will be appreciated that such communication may exist, in addition or in alternate via the communication device 424 and/or the overlay device 428. In other words, any particular input to the PTR 210 as shown in FIG. 4 may additionally, or alternatively, be supplied as input to one or both of the communication device 424 and the overlay device 428.

As alluded to above, the PTR 210 may be used to provide home automation functionality, but the overlay device 428 may be used to modify a particular signal so that particular home automation information may be presented via the display device 430. Further, the home automation functionality as detailed throughout in relation to the PTR 210 may alternatively be provided by or via the overlay device 428. Using the overlay device 428 to present automation information via the display device 430 may be beneficial and/or advantageous in many respects. For instance, it is contemplated that multiple devices may provide input video to the overlay device 428. For instance, the PTR 210 may provide television programming to the overlay device 428, a DVD/Blu-Ray player may provide video to the overlay device 428, and a separate IPTV device may stream other programming to the overlay device 428.

Regardless of the source of particular video/audio, the overlay device 428 may output video and/or audio that has been modified or augmented, etc., to include home automation information and then output to the display device 430. As such, regardless of the source of video/audio, the overlay device 428 may modify the audio/video to include home automation information and, possibly, solicit user input. For instance, in some examples the overlay device 428 may have four video inputs (e.g., four HDMI inputs) and a single video output (e.g., an HDMI output). In other examples, the PTR 210 may exhibit such features or functionality. As such, a separate device, such as a Blu-ray player may be connected with a video input of the PTR 210, thus allowing the PTR 210 to overlay home automation information when content from the Blu-Ray player is being output to the display device 430.

Regardless of whether the PTR 210 is itself configured to provide home automation functionality and output home automation input for display via the display device 430 or such home automation functionality is provided via the overlay device 428, home automation information may be presented by the display device 430 while television programming is also being presented by display device 430. For instance, home automation information may be overlaid or may replace a portion of television programming, such as broadcast content, stored content, on-demand content, etc., presented via the display device 430. FIG. 2 shows an example display by the television 214c, the same of which is supplied to the television 214c by the PTR 210 which may be configured to host the home automation system 400 in accordance with the principles of the present disclosure. In FIG. 2, while television programming consisting of a baseball game is being presented, the display may be augmented with information related to home automation. In general, the television programming may represent broadcast programming, recorded content, on-demand content, or some other form of content.

An example of information related to home automation may include a security camera feed, as acquired by a camera at a front door of a residence. Such augmentation of the television programming may be performed directly by the PTR 210 (which may or may not be in communication with the communication device 424), the overlay device 428, or a combination thereof. Such augmentation may result in solid or opaque or partially transparent graphics being overlaid onto television programming (or other forms of video) output by the PTR 210 and displayed by the television 214c. Furthermore, the overlay device 428 and/or the PTR 210 may add or modify sound to television programming also or alternatively. For instance, in response to a doorbell ring, a sound may be played through the television 214c (or connected audio system). In addition or in alternate, a graphic may be displayed. In other examples, other particular camera data (e.g., nanny camera data) and/or associated sound or motion sensors may be integrated in the system and overlaid or otherwise made available to a user. For example, detection of a crying baby from a nanny camera may trigger an on-screen alert to a user watching television.

Returning to FIG. 4, the PTR 210 and/or the overlay device 428, depending on implementation-specific details, may communicate with one or more wireless devices, such as the third party device 420. The third party device 420 may represent a tablet computer, cellular phone, laptop computer, remote computer, or some other device through which a user may desire to control home automation settings and view home automation information in accordance with the principles of the present disclosure. Such a device also need not necessarily be wireless, such as in a desktop computer example. It is contemplated that the PTR 210, communication device 424, and/or the overlay device 428 may communicate directly with the third party device 420, or may use a local wireless network, such as network 224, for instance. The third party device 420 may be remotely located and not connected with a same local wireless network as one or more of the other devices or elements of FIG. 4. Via the Internet, the PTR 210 and/or the overlay device 428 may transmit a notification to the third party device 420 regarding home automation information. For instance, a third-party notification server system, such as a notification server system operated by Apple Inc., of Cupertino, Calif. may be used to send such notifications to the third party device 420.

Various home automation devices may be in communication with the OSS module 220 of the PTR 210 (collectively, “PTR 210” throughout) and/or the overlay device 428, depending on implementation-specific details. Such home automation devices may use similar or disparate communication protocols. Such home automation devices may communicate with the PTR 210 directly or via the communication device 424. Such home automation devices may be controlled by a user and/or have a status viewed by a user via the display device 430 and/or third party device 420. Such home automation devices may include, but are not limited to:

One or more cameras, such as the security camera 408. It is contemplated that the security camera 408 may be installed indoors or outdoors, and may provide a video and/or an audio stream that may be presented via the third party device 420 and/or display device 430. Video and/or audio from the security camera 408 may be recorded by the overlay device 428 and/or the PTR 210 continuously, in a loop as per a predefined time period, upon an event occurring, such as motion being detected by the security camera 408, etc. For example, video and/or audio from security camera 408 may be continuously recorded such as in the form of a rolling window, thus allowing a period of time of video/audio to be reviewed by a user from before a triggering event and after the triggering event. Video/audio may be recorded on a persistent storage device local to overlay device 428 and/or the PTR 210, and/or may be recorded and stored on an external storage devices, such as a network attached storage device or the server 218 of FIG. 2. In some examples, video may be transmitted across a local and/or wide area network to other one or more other storage devices upon occurrence of a trigger event for later playback, for example. In one implementation, a still image may be captured by the security camera 408 and stored by the PTR 210 for subsequent presentation as part of a user interface via the display device 430. In this way, an end-user can determine which camera, if multiple cameras are present or enabled, is being set up and/or later accessed. For example, a user interface may display a still image from a front door camera, which may be easily recognized by the user because it shows a scene near or adjacent a front door of a residence, to allow a user to select the front door camera for viewing as desired.

Furthermore, video and/or audio from the security camera 408 may be available live for viewing by a user via the overlay device 428 or the PTR 210. Such video/audio may be presented simultaneously with television programming being presented. In some examples, video may only be presented if motion is detected by the security camera 408, otherwise video from the security camera 408 may not be presented by a particular display device presenting television programming. Also, such video (and, possibly, audio) from the security camera 408 may be recorded by the PTR 210 and/or the overlay device 428. In some examples, such video/audio may be recorded based upon a user-configurable timer. For instance, features or functionality associated with the security camera 408 may be incorporated into an EPG that is output by the PTR 210 for display by a presentation or display device.

For instance, data as captured by the security camera 408 may be presented or may otherwise be accessible as a “channel” as part of the EPG along with other typical or conventional television programming channels. Accordingly, a user may be permitted to select that channel associated with the security camera 408 to access data as captured by the security camera 408 for presentation via the display device 430 and/or the third party device 420, etc. The user may also be permitted to set a timer to activate the security camera 408 to record video and/or audio for a user-defined period of time on a user-defined date, for example. Such recording may not be constrained by the rolling window mentioned above associated with a triggering event being detected. Such an implementation may be beneficial, for example, if a babysitter is going to be watching a child and the parents want to later review the babysitter's behavior in their absence. In some examples, video and/audio acquired by the security camera 408 may be backed up to a remote storage device, such as cloud-based storage hosted by the server 218 of FIG. 2 for instance. Other data may also be cached to the cloud, such as configuration settings. Thus, if one or both of the PTR 210 and overlay device 428 malfunction, then a new device may be installed and the configuration data loaded onto the device from the cloud.

Further, one or more window sensors and door sensors, such as the window sensor 410 and the door sensor 412 may be integrated into or as part of the home automation system 400, and each may transmit data to the PTR 210, possibly via the communication device 424, or the overlay device 428, that indicates the status of a window or door, respectively. Such status may indicate open window or door, an ajar window or door, a closed window or door, etc. When a status change occurs, an end-user may be notified as such via the third party device 420 and/or the display device 430, within an EPG or like interface, for example. Further, a user may be able to view a status screen within an EPG or other interface to view the status of one or more window sensors and/or one or more door sensors throughout the location. In some examples, the window sensor 410 and/or the door sensor 412 may have integrated “break” sensors to enable a determination as to whether glass or a hinge, or other integral component, etc., has been broken or compromised. Here, as well as in other instances of home automation related data as acquired and served to the PTR 210 and/or overlay device 428 by particular elements of FIG. 4, it is contemplated that one or both of the window sensor 410 and the door sensor 412 may be controlled via interaction with particular controls as provided within or by an EPG or like interface, and information or data as acquired by one or both of the window sensor 410 and door sensor 412 may be manipulated, consolidated, etc., as desired, and also made accessible within or by an EPG or like interface, such as a pop-up window, banner, and/or any other “interface” or “display” or the like, in accordance with the principles of the present disclosure.

Further, one or more smoke, CO, and/or CO₂ detectors, such as detector 404, may be integrated into or as part of the home automation system 400. As such, alerts as to whether a fire (e.g., heat, smoke), CO, CO₂, radon, etc., has been detected can be sent to the PTR 210, third party device 420, etc., and/or one or more emergency first responders. Accordingly, when an alert occurs, a user may be notified as such the via third party device 420 or the display device 430, within an EPG or like interface for example. Further, it is contemplated that such an interface may be utilized to disable false alarms, and that one or more sensors dispersed throughout a residence and/or integrated within the home automation system 400 to detect gas leaks, radon, or various other dangerous situations. Here, as well as in other instances of home automation related data as acquired and served to the PTR 210 and/or overlay device 428 by particular elements of FIG. 4, the detector 404 may be controlled via interaction with particular controls as provided within or by an EPG or like interface, and information or data as acquired by the detector 404 may be manipulated, consolidated, etc., as desired, and also made accessible within or by an EPG or like interface in accordance with the principles of the present disclosure.

Further, a pet door and/or feeder, such as pet door and/or feeder 402 may be integrated into or as part of the home automation system 400. For instance, a predefined amount of food may be dispensed at predefined times to a pet. A pet door may be locked and/or unlocked. The pet's weight or presence may trigger the locking or unlocking of the pet door. For instance, a camera located at the pet door may be used to perform image recognition of the pet or a weight sensor near the door may identify the presence of the pet and unlock the door. A user may also lock/unlock a pet door and/or dispense food, for example, from a “remote” location. Here, as well as in other instances of home automation related data as acquired and served to the PTR 210 and/or overlay device 428 by particular elements of FIG. 4, the pet door and/or feeder 402 may be controlled via interaction with particular controls as provided within or by an EPG or like interface, and information or data as acquired by the pet door and/or feeder 402 may be consolidated, summarized, etc., and made accessible within or by an EPG or like interface in accordance with the principles of the present disclosure.

Further, a weather sensor, such as the weather sensor 414 may be integrated into or as part of the home automation system 400, and may allow or enable the PTR 210 and/or overlay device 428 to receive, identify, and/or output various forms of environmental data, including local or non-local ambient temperature, humidity, wind speed, barometric pressure, etc. Here, as well as in other instances of home automation related data as acquired and served to the PTR 210 and/or overlay device 428 by particular elements of FIG. 4, the weather sensor 414 may be controlled via interaction with particular controls as provided within or by an EPG or like interface, and information or data as acquired by the pet door and/or feeder 402 may be manipulated, consolidated, etc., as desired, and also made accessible within or by an EPG or like interface in accordance with the principles of the present disclosure.

Further, a shade controller, such as shade controller 416, may be integrated into or as part of the home automation system 400, and may allow for control of one or more shades, such as window, door, and/or skylight shades, within a home or residence or any other location. The shade controller 416 may respond to commands received from the PTR 210 and/or overlay device 428 and may provide status updates, such as “shade up” or “shade 50% up” or “shade down,” etc. Here, as well as in other instances of home automation related data as acquired and served to the PTR 210 and/or overlay device 428 by particular elements of FIG. 4, the shade controller 416 may be controlled via interaction with particular controls as provided within or by an EPG or like interface, and information or data as acquired by the shade controller 416 may be manipulated, consolidated, etc., as desired, and also made accessible within or by an EPG or like interface in accordance with the principles of the present disclosure.

Further, a utility monitor, such as utility monitor 418, may be integrated into or as part of the home automation system 400, and may serve to provide the PTR 210 and/or overlay device 428 with utility data or information, such as electricity usage, gas usage, water usage, wastewater usage, irrigation usage, etc. A user may, via an EPG or like interface, view a status page or may receive notifications upon predefined events occurring, such as electricity usage exceeding a defined threshold within a month, or current kilowatt usage exceeding a threshold. Here, as well as in other instances of home automation related data as acquired and served to the PTR 210 and/or overlay device 428 by particular elements of FIG. 4, the utility monitor 418 may be controlled via interaction with particular controls as provided within or by an EPG or like interface, and information or data as acquired by the utility monitor 418 may be manipulated, consolidated, etc., as desired, and also made accessible within or by an EPG or like interface in accordance with the principles of the present disclosure.

Further, a health sensor, such as health sensor 422, may be integrated into or as part of the home automation system 400, and may permit one or more vital characteristics of a particular individual to be acquired and/or monitored, such as a heart rate, for instance. In some examples, additionally or alternatively, the health sensor 422 may contain a button or other type of actuator that a user can press to request assistance. As such, the health sensor 422 may be mounted to a fixed location, such as a bedside, or may be carried by a user, such as on a lanyard. Such a request may trigger a notification to be presented to other users via the display device 430 and/or the third party device 420. Additionally or if the notification is not cleared by another user within a predefined period of time, a notification may be transmitted to emergency first responders to request help. In some examples, a home automation service provider may first try contacting the user, such as via phone, to determine if an emergency is indeed occurring. Such a health sensor 422 may have additional purposes, such as for notification of another form of emergency, such as a break-in, fire, flood, theft, disaster, etc.

In some examples, the health sensor 422 may be used as a medical alert pendant that can be worn or otherwise carried by an individual. It may contain a microphone and/or speaker to allow communication with other users and/or emergency first responders. The PTR 210 and/or overlay device 428 may be preprogrammed to contact a particular phone number, such as an emergency service provider, relative, caregiver, etc., based on an actuator of the health sensor 422 being activated by a user. The user may be placed in contact with a person via the phone number and the microphone and/or speaker of the health sensor 422. Furthermore, camera data may be combined with such alerts in order to give a contacted relative more information regarding the medical situation. For example, the health sensor 422, when activated in the family room, may generate a command which is linked with security camera footage from the same room. Furthermore, in some examples, the health sensor 422 may be able to monitor vitals of a user, such as a blood pressure, temperature, heart rate, blood sugar, etc. In some examples, an event, such as a fall or exiting a structure can be detected.

Further, in response to an alert from the health sensor 422 or some other emergency or noteworthy event, parallel notifications may be sent to multiple users at approximately the same time. As such, multiple people can be made aware of the event at approximately the same time (as opposed to serial notification). Therefore, whoever the event is most pertinent to or notices the notification first can respond. Which users are notified for which type of event may be customized by a user of the PTR 210. In addition to such parallel notifications being based on data from the health sensor 422, data from other devices may trigger such parallel notifications. For instance, a mailbox open, a garage door open, an entry/exit door open during wrong time, an unauthorized control of specific lights during vacation period, a water sensor detecting a leak or flow, a temperature of a room or equipment falling outside of defined range, and/or motion detected at front door are examples of possible events that may trigger parallel notifications.

Additionally, a configuring user may be able to select from a list of users to notify and from various notification methods to enable such parallel notifications. The configuring user may prioritize which systems and people are notified and specify that the notification may continue through the list unless acknowledged either electronically or by human interaction. For example, the user may specify that they want to be notified of any light switch operation in their home during their vacation. Notification priority could be: 1) SMS Message; 2) push notification; 3) electronic voice recorder places call to primary number; and 4) electronic voice recorder places call to spouse's number. Other examples are possible, however, it is contemplated that the second notification may never happen if the user replies to the SMS message with an acknowledgment. Optionally, the second notification may automatically happen if the SMS gateway cannot be contacted. Here, as well as in other instances of home automation related data as acquired and served to the PTR 210 and/or overlay device 428 by particular elements of FIG. 4, the health sensor 422 may be controlled via interaction with particular controls as provided within or by an EPG or like interface, and information or data as acquired by the health sensor 422 may be manipulated, consolidated, etc., as desired, and also made accessible within or by an EPG or like interface in accordance with the principles of the present disclosure.

Further, an intercom, such as the intercom 426, may be integrated into or as part of the home automation system 400, and may permit a user in one location to communicate with a user in another location, who may be using the third party device 420, the display device 430, or some other device, such as another television receiver. The intercom 426 may be integrated with the security camera 408 or may use a dedicated microphone/speaker, such as a Bluetooth® microphone. Microphones/speakers of the third party device 420, display device 430, communication device 242, overlay device 428, etc., may also or alternatively be used. A MoCA network or other appropriate type of network may be used to provide audio and/or video from the intercom 426 to the PTR 210 and/or to other television receivers and/or wireless devices in communication with the PTR 210. Here, as well as in other instances of home automation related data as acquired and served to the PTR 210 and/or overlay device 428 by particular elements of FIG. 4, the intercom 426 may be controlled via interaction with particular controls as provided within or by an EPG or like interface, and information or data as acquired by the intercom 426 may be manipulated, consolidated, etc., as desired, and also made accessible within or by an EPG or like interface in accordance with the principles of the present disclosure.

Further, a light controller, such as light controller 434, may be integrated into or as part of the home automation system 400, and may permit a light to be turned on, off, and/or dimmed by the PTR 210 or the overlay device 428, such as based on a user command received from the third party device 420 or directly via PTR 210 or overlay device 428, etc. The light controller 434 may control a single light. As such, multiple instances of light controller 434 may be present within a house or residence. In some examples, a physical light switch that opens and closes a circuit of the light may be left in the “on” position such that light controller 434 can be used to control whether the light is on or off. The light controller 434 may be integrated into a light bulb or a circuit, such as between the light fixture and the power source, to control whether the light is on or off. An end-user, via the PTR 210 or overlay device 428, may be permitted to view a status of each instance of the light controller 434 within a location.

Since the PTR 210 or overlay device 428 may communicate using different home automation protocols, different instances of the light controller 434 within a location may use disparate or different communication protocols, but may all still be controlled by the PTR 210 or overlay device 428. In some examples, wireless light switches may be used that communicate with the PTR 210 or overlay device 428. Such switches may use a different communication protocol than any particular instance of the light controller 434. Such a difference may not affect functionality because the PTR 210 or overlay device 428 can serve as a hub for multiple disparate communication protocols and perform any necessary translation and/or bridging functions. For example, a tablet computer may transmit a command over a WiFi connection and the PTR 210 or overlay device 428 may translate the command into an appropriate Zigbee® or Zwave® command for a wireless light bulb. In some examples, the translation may occur for a group of disparate or different devices. For example, a user may decide to turn off all lights in a room and select a lighting command on a tablet computer, the overlay device 428 may then identify the lights in the room and output appropriate commands to all devices over different protocols, such as a Zigbee® wireless light bulb and a Zwave® table lamp.

Additionally, it is contemplated that the PTR 210 may permit timers and/or dimmer settings to be set for lights via the light controller 434. For instance, lights can be configured to turn on/off at various times according to a schedule and/or events being detected by the home automation system 400, etc. Here, as well as in other instances of home automation related data as acquired and served to the PTR 210 and/or overlay device 428 by particular elements of FIG. 4, each particular instance of the light controller 434 may be controlled via interaction with particular controls as provided within or by an EPG or like interface, and information or data as acquired by each particular instance of the light controller 434 may be manipulated, consolidated, etc., as desired, and also made accessible within or by an EPG or like interface in accordance with the principles of the present disclosure.

Further, a thermostat, such as the thermostat 436, may be integrated into or as part of the home automation system 400, and may provide heating/cooling updates to the PTR 210 and/or overlay device 428 for display via display device 430 and/or third party device 420. Further, control of thermostat 436 may be effectuated via the PTR 210 or overlay device 428, and zone control within a structure using multiple thermostats may also be possible. Here, as well as in other instances of home automation related data as acquired and served to the PTR 210 and/or overlay device 428 by particular elements of FIG. 4, the thermostat 436 may be controlled via interaction with particular controls as provided within or by an EPG or like interface, and information or data as acquired by the thermostat 436 may be manipulated, consolidated, etc., as desired, and also made accessible within or by an EPG or like interface in accordance with the principles of the present disclosure.

Further, a leak detection sensor, such as the leak detection sensor 438, may be integrated into or as part of the home automation system 400, and may be used to determine when a water leak has occurred, such as in pipes supplying faucet fixtures with water. The leak detection sensor 438 may be configured to attach to the exterior of a pipe and listen for a sound of water moving within a pipe. In other examples, sonar, temperature sensors or ion infused water with appropriate sensors may be used to detect moving water. As such, cutting or otherwise modifying plumbing may not be necessary to use or leverage the leak detection sensor 438. If water movement is detected for greater than a threshold period of time, it may be determined that a leak is occurring. The leak detection sensor 438 may have a component that couples over an existing valve such that the flow of water within one or more pipes can be stopped.

For instance, if the leak detection sensor 438 determines a leak may be occurring, a notification may be provided to a user via the third party device 420 and/or display device 430 by the PTR 210 and/or overlay device 428. If a user does not clear the notification, the flow of water may be shut off by the leak detection sensor 438 after a predefined period of time, for example. A user may also be able to provide input to allow the flow of water to continue or to immediately interrupt the flow of water. Here, as well as in other instances of home automation related data as acquired and served to the PTR 210 and/or overlay device 428 by particular elements of FIG. 4, the leak detection sensor 438 may be controlled via interaction with particular controls as provided within or by an EPG or like interface, and information or data as acquired by the leak detection sensor 438 may be manipulated, consolidated, etc., as desired, and also made accessible within or by an EPG or like interface in accordance with the principles of the present disclosure.

Further, an appliance controller, such as the appliance controller 440, may be integrated into or as part of the home automation system 400, and may permit a status of an appliance to be retrieved and commands to control operation to be sent to an appliance by the PTR 210 or overlay device 428. For instance, the appliance controller 440 may control a washing machine, a dryer, a dishwasher, an oven, a microwave, a refrigerator, a toaster, a coffee maker, a hot tub, or any other form of appliance. The appliance controller 440 may be connected with a particular appliance or may be integrated as part of the appliance. Additionally, or alternatively, the appliance controller 440 may enable acquisition of data or information regarding electricity usage of one or more devices (e.g., other home automation devices or circuits within a home that are monitored). Here, as well as in other instances of home automation related data as acquired and served to the PTR 210 and/or overlay device 428 by particular elements of FIG. 4, the appliance controller 440 may be controlled via interaction with particular controls as provided within or by an EPG or like interface, and information or data as acquired by the appliance controller 440 may be manipulated, consolidated, etc., as desired, and also made accessible within or by an EPG or like interface in accordance with the principles of the present disclosure.

Further, a garage door controller, such as the garage door controller 442, may be integrated into or as part of the home automation system 400, and may permit a status of a garage door to be checked and the door to be opened or closed by a user via the PTR 210 or overlay device 428. In some examples, based on a physical location of the third party device 420, the garage door may be controlled. For instance, if the third party device 420 is a cellular phone and it is detected to have moved a threshold distance away from a house having the garage door controller 442 installed, a notification may be sent to the third party device 420. If no response is received within a threshold period of time, the garage may be automatically shut. If the third party device 420 moves within a threshold distance of the garage door controller 442, the garage may be opened. Here, as well as in other instances of home automation related data as acquired and served to the PTR 210 and/or overlay device 428 by particular elements of FIG. 4, the garage door controller 442 may be controlled via interaction with particular controls as provided within or by an EPG or like interface, and information or data as acquired by the garage door controller 442 may be manipulated, consolidated, etc., as desired, and also made accessible within or by an EPG or like interface in accordance with the principles of the present disclosure.

Further, a lock controller, such as the lock controller 444, may be integrated into or as part of the home automation system 400, and may permit a door to be locked and unlocked and/or monitored by a user via the PTR 210 or overlay device 428. In some examples, the lock controller 444 may have an integrated door sensor 412 to determine if the door is open, shut, or partially ajar. Being able to only determine if a door is locked or unlocked may not be useful. For instance, if a lock is in a locked position but the door is ajar, the lock may not prevent access to the house. Therefore, for security, a user may benefit from knowing both that a door is closed (or open) and locked (or unlocked). To accomplish such notification and control, the lock controller 444 may have an integrated door sensor 412 that allows for the lock controller 444 to lock/unlock a door and provide a status as to whether the door is open or shut. Therefore, a single device may control a lock and determine whether the associated door is shut or open. No mechanical or electrical component may need to be integrated separately into a door or doorframe to provide such functionality. Such a single device may have a single power source that allows for sensing of the lock position, sensing of the door position, and for engagement/disengagement of the lock.

For example, the lock controller 444 may have an integrated door sensor that includes a reed switch or proximity sensor that detects when the door is in a closed position, with a plate of the lock in proximity to a plate on the door frame of the door. For instance, a plate of the lock may have an integrated magnet or magnetized doorframe plate. When in proximity to the magnet, a reed switch located in the lock controller 444 may be used to determine that the door is closed; when not in proximity to the magnet, the reed switch located in the lock controller 444 may be used to determine that the door is at least partially ajar. Rather than using a reed switch, other forms of sensing may also be used, such as a proximity sensor to detect a doorframe. In some examples, the sensor to determine the door is shut may be integrated directly into the deadbolt or other latching mechanism of the lock controller 444. When the deadbolt is extended, a sensor may be able to determine if the distal end of the deadbolt is properly latched within a door frame based on a proximity sensor or other sensing means. Here, as well as in other instances of home automation related data as acquired and served to the PTR 210 and/or overlay device 428 by particular elements of FIG. 4, the lock controller 444 may be controlled via interaction with particular controls as provided within or by an EPG or like interface, and information or data as acquired by the lock controller 444 may be manipulated, consolidated, etc., as desired, and also made accessible within or by an EPG or like interface in accordance with the principles of the present disclosure.

Further, a home security system, such as the home security system 406, may be integrated into or as part of the home automation system 400. In general, the home security system 406 may detect motion, when a user has armed/disarmed the home security system 406, when windows/doors are opened or broken, etc. The PTR 210 may adjust settings of the home automation devices of FIG. 4 based on home security system 406 being armed or disarmed. For example, a virtual control and alarm panel may be presented to a user via the display device 430. The functions of a wall mounted panel alarm can be integrated in the graphical user interface of the TV viewing experience such as a menu system with an underlying tree hierarchical structure. It is contemplated that the virtual control and alarm panel can appear in a full screen or PiP (Picture-in-Picture) with TV content. Alarms and event notification can be in the form of scrolling text overlays, popups, flashing icons, etc.

Additionally, camera video and/or audio, such as from the security camera 408, can be integrated with DVR content provided by the PTR 210 with additional search, zoom, time-line capabilities. The camera's video stream can be displayed full screen, PiP with TV content, or as a tiled mosaic to display multiple camera's streams at a same time. In some examples, the display can switch between camera streams at fixed intervals. The PTR 210 may perform video scaling, adjust frame rate and transcoding on video received from the security camera 408. In addition, the PTR 210 may adaptively transcode the camera content to match an Internet connection. Here, as well as in other instances of home automation related data as acquired and served to the PTR 210 and/or overlay device 428 by particular elements of FIG. 4, the home security system 406 may be controlled via interaction with particular controls as provided within or by an EPG or like interface, and information or data as acquired by the home security system 406 may be manipulated, consolidated, etc., as desired, and also made accessible within or by an EPG or like interface in accordance with the principles of the present disclosure.

Further, an irrigation controller, such as the irrigation controller 446, may be integrated into or as part of the home automation system 400, and may allow for a status and control of an irrigation system, such as a sprinkler system, to be controlled by a user via the PTR 210 and/or overlay device 428. The irrigation controller 446 may be used in conjunction with the weather sensor 414 to determine whether and/or for how long (duration) the irrigation controller 446 should be activated for watering. Further, a user, via the PTR 210 and/or overlay device 428, may turn on, turn off, or adjust settings of the irrigation controller 446. Here, as well as in other instances of home automation related data as acquired and served to the PTR 210 and/or overlay device 428 by particular elements of FIG. 4, the irrigation controller 446 may be controlled via interaction with particular controls as provided within or by an EPG or like interface, and information or data as acquired by the irrigation controller 446 may be manipulated, consolidated, etc., as desired, and also made accessible within or by an EPG or like interface in accordance with the principles of the present disclosure.

Further, a doorbell sensor, such as the doorbell sensor 448, may be integrated into or as part of the home automation system 400, and may permit an indication of when a doorbell has been rung to be sent to multiple devices, such as the PTR 210 and/or the third party device 420. In some examples, the doorbell sensor 448 detecting a doorbell ring may trigger video to be recorded by the security camera 408 of the area near the doorbell and the video to be stored until deleted by a user, or stored for predefined period of time, for example. Here, as well as in other instances of home automation related data as acquired and served to the PTR 210 and/or overlay device 428 by particular elements of FIG. 4, the doorbell sensor 448 may be controlled via interaction with particular controls as provided within or by an EPG or like interface, and information or data as acquired by the doorbell sensor 448 may be manipulated, consolidated, etc., as desired, and also made accessible within or by an EPG or like interface in accordance with the principles of the present disclosure.

For example, “selection” of a doorbell by an individual so as to “trigger” the doorbell sensor 448 may activate or engage the PTR 210 to generate and output for display by a presentation device, such as the television 214c, a user interface, display, pop-up, etc., that which may include particular information such as “There is someone at your front door ringing the doorbell” for example. Additional, or alternative, actions such as activating, by the PTR 210, a security camera to record video and/or audio of the individual at the front door are contemplated as well. Further, similar steps or actions may be taken or implemented by the PTR 210 for example in response to a signal generated in response to detection of an event, etc., received by the PTR 210 from any of the elements of FIG. 4.

Additional forms of sensors not illustrated in FIG. 4 may also be incorporated as part of the home automation system 400. For instance, a mailbox sensor may be attached to a mailbox to determine when mail is present and/or has been picked up. The ability to control one or more showers, baths, and/or faucets from the PTR 210 and/or the third party device 420 may also be possible. Pool and/or hot tub monitors may be incorporated into the home automation system 400. Such sensors may detect whether or not a pump is running, water temperature, pH level, a splash/whether something has fallen in, etc. Further, various characteristics of the pool and/or hot tub may be controlled via the home automation system. In some examples, a vehicle “dashcam” may upload or otherwise make video/audio available to the PTR 210 when within range of a particular residence. For instance, when a vehicle has been parked within range of a local wireless network with which the PTR 210 is connected, video and/or audio may be transmitted from the dashcam to the PTR 210 for storage and/or uploading to a remote server, such as the server 218 as shown in FIG. 2. Here, as well as in other instances of home automation related data as acquired and served to the PTR 210 and/or overlay device 428 by particular elements of FIG. 3, such systems or sensors or devices may be controlled via interaction with particular controls as provided within or by an EPG or like interface, and information or data as acquired by such systems or sensors or devices may be manipulated, consolidated, etc., as desired, and also made accessible within or by an EPG or like interface in accordance with the principles of the present disclosure.

Referring now to FIG. 5, first example aspects of the home automation system 400 of FIG. 4 are shown in detail. In particular, the PTR 210 in an in-home implementation or scenario, and/or possibly server 218 in a remote access implementation or scenario (via mobile device 216a for example), may be configured to output an EPG (Electronic Programming Guide) 502 to and for presentation by the television 214c, or the mobile device 216a, for example. The EPG 502 may at least present various information related to television channels and the timing of programs or programming appearing on such television channels. For example, as shown in FIG. 5, the EPG 502 may display information associated with a Channel 2014, where, just as an example, the World Series is listed as scheduled to appear on that channel starting at a particular time on a particular day, etc. In this example, and assuming that a current time is sometime during the time period 8-10 PM, a viewer may manipulate a cursor 504 using a pointing device (not shown) to select, as indicated by stipple shading in FIG. 5, the World Series for immediate viewing within a window 506 on the television 214c. Other examples are possible. For example, it is contemplated that any menu-driven navigation technique or implementation may be used to enable user-interaction with the EPG 502, along with any other elements or interfaces output by the PTR 210 to the television 214c or the mobile device 216a.

In addition to the EPG 502 in FIG. 5, the PTR 210 (and/or server 218) may be configured and/or arranged to output various other interactive elements or interfaces in accordance with the principles of the present disclosure. For example, the OSS module 220 of the PTR 210 may be configured or programmed to output for display a configuration selection 508. It is contemplated that the configuration selection 508 may, in general, when selected, instantiate a process to enable a user or viewer to configure the OSS module 220 to implement a particular home occupancy simulation routine according to the principles of the present disclosure. For example, a user may manipulate the cursor 504 to select (e.g., “double-click”) the configuration selection 508 and, in response, the OSS module 220 may output a configuration interface 510 to and for presentation by the television 214c.

In this example, the configuration interface 510 may permit a user to select, via pick list 512 for example, between a default occupancy simulation mode 514, a user-defined occupancy simulation mode 516, and a recommended occupancy simulation mode 518, either of which when engaged or enabled may be implemented accordingly in response to a command to do so (e.g., step 102 of FIG. 1). In particular, the default occupancy simulation mode 514 may include or comprise instructions for timed activation/deactivation, possibly in tandem with a particular degree of randomness, of particular home automation devices or components of the home automation system 400 of FIG. 4, based upon usage information supplied to the OSS module 220 by one or more of the particular home automation devices or components, or via monitoring of usage of one or more of the particular home automation devices or components.

As an example, it is contemplated that the light controller 434 of FIG. 4 may periodically or at least intermittently report to the OSS module 220 details associated with the ON/OFF switching of a lamp in a living room:

Monday—7 PM(ON)/9 PM(OFF);

Tuesday—8 PM(ON)/10 PM(OFF);

Wednesday—7 PM(ON)/7:30 PM(OFF);

Thursday—7 PM(ON)/10 PM(OFF);

Friday—10 PM(ON)/12 AM(OFF);

Saturday—9 PM(ON)/2 AM(OFF);

Sunday—7 PM(ON)/10 PM(OFF).

In this example, the OSS module 220 may determine that the lamp in the living room is typically ON between 7 PM and 10 PM Monday-Thursday and Sunday, and is typically ON between 9 PM and 2 AM Friday and Saturday. It is contemplated that the OSS module 220 may then program itself to switch ON and then OFF the lamp in the living room in accordance with the above data, when the default occupancy simulation mode 514 is active or engaged. In some examples, the OSS module 220 may too inject randomness so that a distinct pattern in the switching ON/OFF of the lamp in the living room could not be readily discerned. For example, on a Monday when the default occupancy simulation mode 514 is active the OSS module 220 may switch ON/OFF the lamp in the living room as: 6:35 PM(ON) and 8:23 PM(OFF), and 9:40 PM(ON) and 10:19 PM(OFF). Then, on a Tuesday when the default occupancy simulation mode 514 is active the OSS module 220 may switch ON/OFF the lamp in the living room as: 7:54 PM(ON) and 9:01 PM(OFF), etc.

As another example, it is contemplated that the OSS module 220 may monitor the times in which audio/video is output by the PTR 210 to the television 214c. Here, the OSS module 220 may estimate based on such information details associated with the ON/OFF switching of the television 214c:

Monday—6 AM(ON)/7:30(OFF) and 7 PM(ON)/9 PM(OFF);

Tuesday—6 AM(ON)/7:30(OFF) and 8 PM(ON)/10 PM(OFF);

Wednesday—6 AM(ON)/7:30(OFF) and 7 PM(ON)/7:30 PM(OFF);

Thursday—6 AM(ON)/7:30(OFF) and 7 PM(ON)/10 PM(OFF);

Friday—6 AM(ON)/7:30(OFF) and 10 PM(ON)/12 AM(OFF);

Saturday—9 PM(ON)/2 AM(OFF);

Sunday—12 PM(ON)/10 PM(OFF).

In this example, similar to the above “light in the living room” scenario, the OSS module 220 may derive or estimate user television viewing habits and then program itself to switch the television 214c ON/OFF (e.g., via “infrared blast”) accordingly, when the default occupancy simulation mode 514 is active or engaged. It is contemplated that such “training” of the OSS module 220 may continue indefinitely and vary as elements or components are added, removed, etc., to and from the home automation system 400 of FIG. 4. Additionally, it is contemplated that correlations may be made. For example, the OSS module 220 may correlate the switching ON/OFF of the lamp to the switching ON/OFF of the television 214c, based on the above example data. The OSS module 220 may then factor in timing and/or randomness for switching ON/OFF of those components accordingly. For example, on a Monday when the default occupancy simulation mode 514 is active the OSS module 220 may switch ON/OFF the lamp in the living room as: 5:32 AM(ON)/7:15 AM(OFF) and 6:35 PM(ON)/8:23 PM(OFF) and 9:40 PM(ON)/10:19 PM(OFF). The OSS module 220 may further, on the Monday when the default occupancy simulation mode 514 is active, switch ON/OFF the television 214c as: 5:54 AM(ON)/7:44 AM(OFF) and 8:15 PM(ON)/9:30 PM(OFF). It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4.

Referring still to FIG. 5, the user-defined occupancy simulation mode 516 may include or comprise instructions for timed activation/deactivation, possibly in tandem with a particular degree of randomness, of particular home automation devices or components of the home automation system 400 of FIG. 4, based upon explicit user input or definitions supplied to the OSS module 220. For example, a user may manipulate the cursor 504 to select (indicated by intermittent line in FIG. 5) the user-defined occupancy simulation mode 516 and, in response, the OSS module 220 may output an interface 520 to and for presentation by the television 214c. In this example, the OSS module 220 may populate the interface 520 with each appliance or other “controllable” home element that in turn may be coupled to a particular one of the home automation devices or components of the home automation system 400 of FIG. 4.

For example, the interface 520 may itemize “Living Room TV” and “Living Room Light(s)” and “Downstairs Light(s)” and “Front Door Light” and so on and so forth. Additionally, the interface 520 may enable a user to explicitly define ON/OFF switching as “8 PM-11 PM” for “Living Room TV” and “6 PM-1 AM” for “Living Room Light(s)” and “ALL DAY” for “Downstairs Light(s)” and “6 PM-6 AM” for “Front Door Light” and so on and so forth. It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4.

Furthermore, the interface 520 may enable a user to independently define a “degree of randomness” to each home automation device or component. For example, “LOW” for “Living Room TV” and “MEDIUM” for “Living Room Light(s)” and “HIGH” for “Downstairs Light(s)” and “NONE” for “Front Door Light” and so on and so forth. It is contemplated that there are many ways by which to quantify degree of randomness in accordance with the present disclosure. As an example, a “LOW” degree of randomness when mapped to a scale of 1-10 may correspond to 1-3, whereby a particular element programmed to exhibit “LOW” degree of randomness may vary only slightly around programmed ON/OFF switch times. For instance, in the “Living Room TV” example, ON/OFF switching of the same may vary +/−10 minutes (maximum) around “8 PM-11 PM” for example. In contrast, a “MEDIUM” degree of randomness when mapped to a scale of 1-10 may correspond to 4-7, whereby a particular element programmed to exhibit “MEDIUM” degree of randomness may vary around programmed ON/OFF switch times greater than that for “LOW” degree of randomness. For instance, in the “Living Room TV” example, ON/OFF switching of the same may vary +/−20 minutes (maximum) around “8 PM-11 PM” for example.

In contrast, a “HIGH” degree of randomness when mapped to a scale of 1-10 may correspond to 8-10, whereby a particular element programmed to exhibit “HIGH” degree of randomness may vary around programmed ON/OFF switch times greater than that for “MEDIUM” degree of randomness. For instance, in the “Living Room TV” example, ON/OFF switching of the same may vary +/−30 minutes (maximum) around “8 PM-11 PM” for example. It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4.

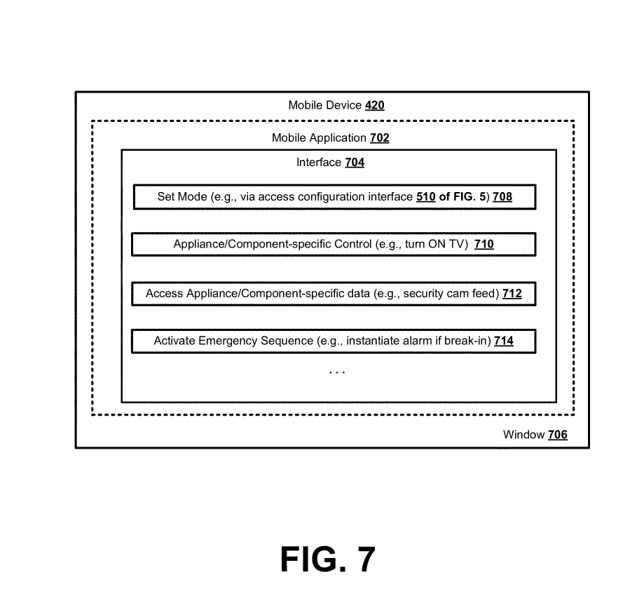

Referring back to the interface 520 of FIG. 5, once programming has been completed, it is contemplated that a user may manipulate the cursor 504 to select (e.g., “double-click”) a save selection 522 and, in response, the OSS module 220 may program the user-defined occupancy simulation mode 516 to exhibit instructions in accordance therewith, so that when the user-defined occupancy simulation mode 516 is engaged or enabled, the same may be implemented accordingly in response to a command to do so (e.g., step 102 of FIG. 1). Here, it is contemplated that a user may manipulate the cursor 504 to select an activate selection 524 to engage or enable the user-defined occupancy simulation mode 516 (or any of the other modes contemplated throughout) when the same is “selected” or “highlighted” (indicated by intermittent line in FIG. 5). Other examples are possible, as discussed in further detail below in connection with FIG. 7. Further, it is contemplated that the configuration interface 510 may itemize a particular simulation mode currently engaged or enabled. For example, as shown in FIG. 5, the configuration interface 510 may indicate “default” or “power save” or “my mode A” or “none” and so on and so forth.

In some examples, an occupancy simulation mode may always be on, learning, sensing occupancy, and simulating occupancy when necessary. It is contemplated that there may be a user interface or control to enable or disable the same based on user input.

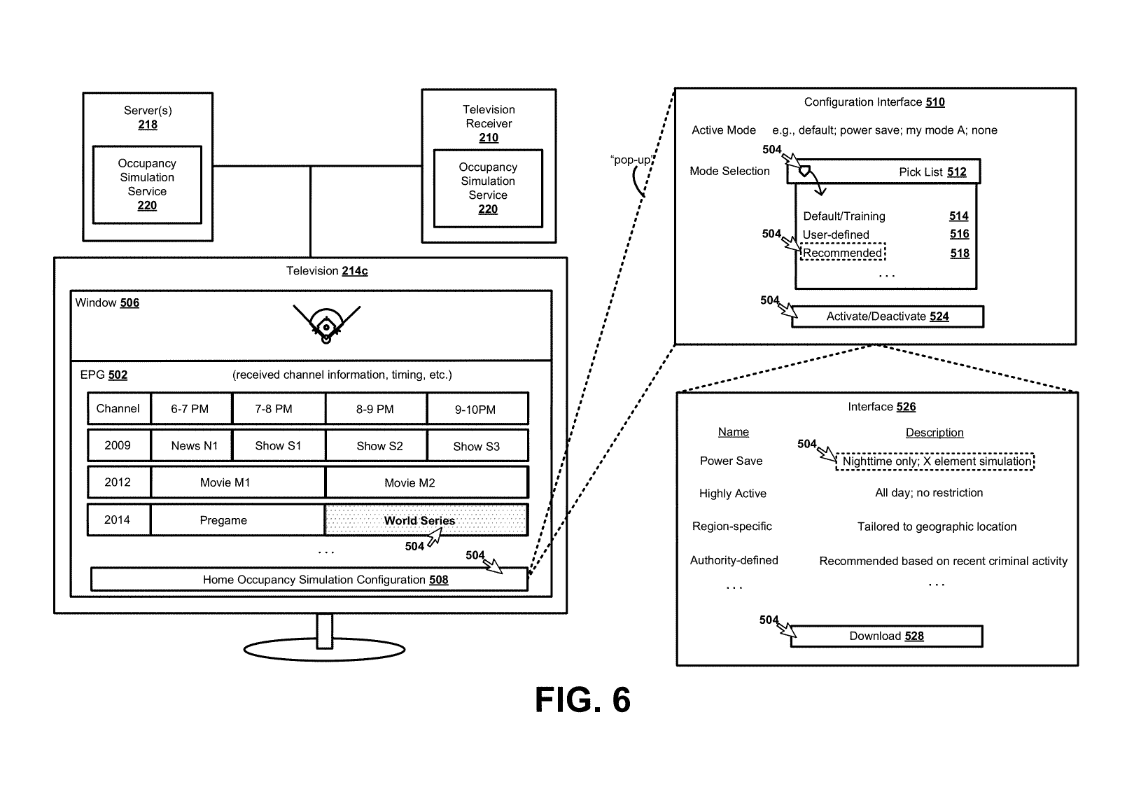

Referring now to FIG. 6, second example aspects of the home automation system 400 of FIG. 4 are shown in detail. In particular, it is contemplated that a user may manipulate the cursor 504 to select (indicated by intermittent line in FIG. 6) the recommended occupancy simulation mode 518 and, in response, the OSS module 220 may output an interface 526 to and for presentation by the television 214c. Similar to other simulated modes discussed throughout, the recommended occupancy simulation mode 518 may include or comprise instructions for timed activation/deactivation, possibly in tandem with a particular degree of randomness, of particular home automation devices or components of the home automation system 400 of FIG. 4. In this example though, particular “recommended simulation modes” may be acquired or prepared or put together or populated by the service provider 202 (see FIG. 2), and then pushed to the server 218 for subsequent access and possible download thereof.

For example, the interface 526 may itemize “Power Save” and “Highly Active” and “Region-specific” and “Authority-defined” and so on and so forth. Additionally, the interface 520 may provide a brief description of each mode “recommended” therein, such as “Nighttime only; X (e.g., integer value) element simulation” that is associated with “Power Save” mode, and “All day; no restriction” that is associated with “Highly Active” mode, and “Tailored to geographic location” that is associated with “Region-specific” mode, and “Recommended based on recent criminal activity” that is associated with “Authority-defined” mode. Here, it is contemplated that a user may manipulate the cursor 504 to select (indicated by intermittent line in FIG. 6) a particular description to access even further detail about each particular mode. For example, “Nighttime only; X (e.g., integer value) element simulation” may be selected to access details such as: “random 90 minute ON/OFF switching period for a first lighting system between the hours of 8 PM-12 AM; random 120 minute ON/OFF switching period for a first lighting system between the hours of 11 PM-2 AM.”

It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4. Furthermore, it is contemplated that a user may manipulate the cursor 504 to select (e.g., “double-click”) a download selection 528 and, in response, the OSS module 220 of the PTR 210 may download a particular recommended home simulation mode or program from the server 218, and then configure the same so that it reflects an instant configuration of the home automation devices or components of the home automation system 400 of FIG. 4. For example, and following download thereof, the OSS module 220 may select a kitchen lamp and map the same to the instruction “random 90 minute ON/OFF switching period for a first lighting system between the hours of 8 PM-12 AM” of the “Power Save” mode, and also select a basement lamp and map the same to the instruction “random 120 minute ON/OFF switching period for a first lighting system between the hours of 11 PM-2 AM” of the “Power Save” mode.

Still further, it is contemplated that an end-user may access the “Power Save” mode, such as in a manner discussed above in connection with FIG. 5, to customize the same according to preference. For example, an end-user may provide explicit input to “reprogram” the “Power Save” mode so that the instruction “random 90 minute ON/OFF switching period for a first lighting system between the hours of 8 PM-12 AM” is mapped to the basement lamp (not the kitchen lamp) of the above-example, and so that the instruction “random 120 minute ON/OFF switching period for a first lighting system between the hours of 11 PM-2 AM.” is mapped to the kitchen lamp (not the basement lamp) of the above-example. It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4.

Referring now to FIG. 7, third example aspects of the home automation system 400 of FIG. 4 are shown in detail. In particular, it is contemplated that a home automation occupancy simulation mobile application 702 may be installed to the third party device 420, exemplified as a mobile device, for example, to enable an end-user to “remotely” implement various features and/or aspects of the present disclosure. For example, an interface 704 of the mobile application 702 as presented or otherwise displayed on a screen or window 706 of the third party device 420 may include a set mode button 708, a control component button 710, a data access button 712, and an instantiate alarm button 714. Other features or functionality are possible. For instance, it is contemplated that the mobile application 702 may include or otherwise exhibit various buttons, control elements, etc., similar to those discussed above in connection with FIGS. 5-6. In this manner, an end-user may implement various features and/or aspects of the present disclosure both locally and remotely, or both at or on or away from their home or residence.

For example, the set mode button 708 may be selected (e.g., via “tap” or “double-tap”) to access the configuration interface 510 of FIG. 5, so as to allow an end-user to select and also activate a particular home occupancy simulation routine or mode, so that the PTR 210 may implement the particular home occupancy simulation routine or mode, in a manner similar to that discussed above in connection with at least FIG. 1. The control component button 710 in contrast may allow an end-user to access an interface to control a particular home element via the PTR 210. For example, an interface similar to the interface 520 of FIG. 5 may include another column adjacent to the “randomness” column with a button or control that when selected may turn ON or OFF “Living Room TV” and “Living Room Lights” etc.

It is contemplated that the data access button 712 may allow an end-user to access an interface and then access data as acquired by a particular home element, via the PTR 210. For example, an interface similar to the interface 520 of FIG. 5 may include another column adjacent to the “randomness” column with a button or control that, when selected, may route an audio/video feed from the security camera 408 of FIG. 4 to the mobile device 420 for presentation thereby. Additionally, the instantiate alarm button 714 may allow an end-user to activate an alarm sequence to contact first responders, police, etc., in event of an emergency or other situation at their home or residence. For example, the end-user may be watching the above-mentioned audio/video feed from the security camera 408 on their mobile device 420 and discover that the front door has been forced ajar, or a fire is present in or at the residence. It will be appreciated that many other examples are possible, and that the foregoing discussion may apply to any of the respective home automation devices or components of the home automation system 400 of FIG. 4. The foregoing discussion may also apply to home automation devices or components not explicitly shown in FIG. 4.

One advantage of the above-described systems/processes is that the home control system may be in a mode to make a house or home or residence appear occupied when users are away. After initial setup and enabling, there is, optionally, no further user intervention required. In embodiments, this advantageously means that the homeowner may never leave their house unprotected due to forgetting to manually set up other devices, or in a situation where the homeowner needed to be gone for some unforeseen reason (medical emergency, etc.). Another advantage is that the system can tailor itself to individual households. Some houses are occupied by large families, small families, shift workers, etc. The system learns the occupants' habits, and then, optionally, simulates the same at the appropriate time automatically.

In embodiments, the OSS may advantageously enable or allow configuration that permit reduced complexity in control over various home automation devices, such as by reducing a number of instructions that may be required to be performed in order to implement control over the home automation devices, such as compared to a number of operations performed in the absence of the OSS.

FIG. 8 shows an example computer system or device 800 in accordance with the disclosure. An example of a computer system or device includes an enterprise server, blade server, desktop computer, laptop computer, tablet computer, personal data assistant, smartphone, gaming console, STB, television receiver, and/or other types of machine. Any particular one of the previously-described computing devices may be wholly or at least partially configured to exhibit features similar to the computer system 800, such as any of the respective elements of at least FIGS. 2-4. In this manner, any of one or more of the respective elements of at least those figures may be configured to perform and/or include instructions that, when executed, perform the method of FIG. 1. Still further, any of one or more of the respective elements of at least FIGS. 2-4 may be configured to perform and/or include instructions that, when executed, instantiate and implement functionality of the PTR 210 and/or the server(s) 218.

The computer device 800 is shown comprising hardware elements that may be electrically coupled via a bus 802 (or may otherwise be in communication, as appropriate). The hardware elements may include a processing unit with one or more processors 804, including without limitation one or more general-purpose processors and/or one or more special-purpose processors (such as digital signal processing chips, graphics acceleration processors, and/or the like); one or more input devices 806, which may include without limitation a remote control, a mouse, a keyboard, and/or the like; and one or more output devices 808, which may include without limitation a presentation device (e.g., television), a printer, and/or the like.

The computer system 800 may further include (and/or be in communication with) one or more non-transitory storage devices 810, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 800 might also include a communications subsystem 812, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 812 may permit data to be exchanged with a network (such as the network described below, to name one example), other computer systems, and/or any other devices described herein. In many examples, the computer system 800 will further comprise a working memory 814, which may include a random access memory and/or a read-only memory device, as described above.

The computer device 800 also may comprise software elements, shown as being currently located within the working memory 814, including an operating system 816, device drivers, executable libraries, and/or other code, such as one or more application programs 818, which may comprise computer programs provided by various examples, and/or may be designed to implement methods, and/or configure systems, provided by other examples, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 810 described above. In some cases, the storage medium might be incorporated within a computer system, such as computer system 800. In other examples, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some examples may employ a computer system (such as the computer device 800) to perform methods in accordance with various examples of the disclosure. According to a set of examples, some or all of the procedures of such methods are performed by the computer system 800 in response to processor 804 executing one or more sequences of one or more instructions (which might be incorporated into the operating system 816 and/or other code, such as an application program 818) contained in the working memory 814. Such instructions may be read into the working memory 814 from another computer-readable medium, such as one or more of the storage device(s) 810. Merely by way of example, execution of the sequences of instructions contained in the working memory 814 may cause the processor(s) 804 to perform one or more procedures of the methods described herein.

The terms “machine-readable medium” and “computer-readable medium,” as used herein, may refer to any non-transitory medium that participates in providing data that causes a machine to operate in a specific fashion. In an example implemented using the computer device 800, various computer-readable media might be involved in providing instructions/code to processor(s) 804 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 810. Volatile media may include, without limitation, dynamic memory, such as the working memory 814.

Example forms of physical and/or tangible computer-readable media may include a floppy disk, a flexible disk, hard disk, magnetic tape, or any other magnetic medium, a compact disc, any other optical medium, ROM (Read Only Memory), RAM (Random Access Memory), etc., any other memory chip or cartridge, or any other medium from which a computer may read instructions and/or code. Various forms of computer-readable media may be involved in carrying one or more sequences of one or more instructions to the processor(s) 804 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 812 (and/or components thereof) generally will receive signals, and the bus 802 then might carry the signals (and/or the data, instructions, etc., carried by the signals) to the working memory 814, from which the processor(s) 804 retrieves and executes the instructions. The instructions received by the working memory 814 may optionally be stored on a non-transitory storage device 810 either before or after execution by the processor(s) 804.

It should further be understood that the components of computer device 800 can be distributed across a network. For example, some processing may be performed in one location using a first processor while other processing may be performed by another processor remote from the first processor. Other components of computer system 800 may be similarly distributed. As such, computer device 800 may be interpreted as a distributed computing system that performs processing in multiple locations. In some instances, computer system 800 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
detecting, by a television receiver, a command to activate a home occupancy simulation to control timing of activation and deactivation of at least one component that is located at a residence and that is communicatively coupled to the television receiver;
selecting, by the television receiver, a particular home occupancy simulation based upon a setting that identifies the particular home automation simulation from among a plurality of home occupancy simulations; and
activating, by the television receiver, the particular home occupancy simulation to control timing of activation and deactivation of the at least one component that is located at the residence and that is communicatively coupled to the television receiver.

2. The method of claim 1, further comprising:
identifying a setting that specifies a particular degree of randomness to be injected into the timing of activation and deactivation of the at least one component; and
injecting, based on the setting, the particular degree of randomness into the timing of activation and deactivation of the at least one component.

3. The method of claim 1, further comprising:
selecting the particular home occupancy simulation based on the setting that identifies the particular home occupancy simulation as one that includes instructions to control timing of activation and deactivation of the at least one component based upon end-user activation and deactivation of the at least one component.

4. The method of claim 1, further comprising:
selecting the particular home occupancy simulation based on the setting that identifies the particular home occupancy simulation as one that includes instructions to control timing of activation and deactivation of the at least one component based upon manual user-input.

5. The method of claim 1, further comprising:
selecting the particular home occupancy simulation based on the setting that identifies the particular home occupancy simulation as one that includes instructions to control timing of activation and deactivation of the at least one component based upon instructions downloaded prior to activation of the particular home occupancy simulation by the television receiver from a computing system over a network connection.

6. The method of claim 1, further comprising:
receiving the command to activate the home occupancy simulation from a mobile device over a network connection based upon selection of a particular control of a mobile application installed to the mobile device.

7. The method of claim 1, further comprising:
activating a particular component that is located at the residence and that is communicatively coupled to the television receiver, based upon a control command received by the television receiver from a mobile device over a network connection.

8. The method of claim 1, further comprising:
receiving, from a mobile device, a control command to access data acquired by a particular component that is located at the residence and that is communicatively coupled to the television receiver; and
transferring, to the mobile device, particular data acquired by the particular component in response to the control command.

9. A television receiver, comprising:
at least one processor; and
at least one memory element communicatively coupled with and readable by at least one processor and having stored therein processor-readable instructions that, when executed by the at least one processor, cause the at least one processor to:
detect a command to activate a home occupancy simulation to control timing of activation and deactivation of at least one component that is located at a residence and that is communicatively coupled to the television receiver;
select a particular home occupancy simulation based upon a setting that identifies the particular home automation simulation from among a plurality of home occupancy simulations; and
activate the particular home occupancy simulation to control timing of activation and deactivation of the at least one component that is located at the residence and that is communicatively coupled to the television receiver.

10. The television receiver of claim 9, wherein the processor-readable instructions when executed by the at least one processor cause the at least one processor to:
identify a setting that specifies a particular degree of randomness to be injected into the timing of activation and deactivation of the at least one component; and
inject, based on the setting, the particular degree of randomness into the timing of activation and deactivation of the at least one component.

11. The television receiver of claim 9, wherein the processor-readable instructions when executed by the at least one processor cause the at least one processor to:
select the particular home occupancy simulation based on the setting that identifies the particular home occupancy simulation as one that includes instructions to control timing of activation and deactivation of the at least one component based upon end-user activation and deactivation of the at least one component.

12. The television receiver of claim 9, wherein the processor-readable instructions when executed by the at least one processor cause the at least one processor to:
select the particular home occupancy simulation based on the setting that identifies the particular home occupancy simulation as one that includes instructions to control timing of activation and deactivation of the at least one component based upon manual user-input.

13. The television receiver of claim 9, wherein the processor-readable instructions when executed by the at least one processor cause the at least one processor to:
select the particular home occupancy simulation based on the setting that identifies the particular home occupancy simulation as one that includes instructions to control timing of activation and deactivation of the at least one component based upon instructions downloaded prior to activation of the particular home occupancy simulation by the television receiver from a computing system over a network connection.

14. The television receiver of claim 9, wherein the processor-readable instructions when executed by the at least one processor cause the at least one processor to:
detect receipt of the command to activate the home occupancy simulation from a mobile device over a network connection based upon selection of a particular control of a mobile application installed to the mobile device.

15. The television receiver of claim 9, wherein the processor-readable instructions when executed by the at least one processor cause the at least one processor to:
activate a particular component that is located at the residence and that is communicatively coupled to the television receiver, based upon a control command received by the television receiver from a mobile device over a network connection.

16. The television receiver of claim 9, wherein the processor-readable instructions when executed by the at least one processor cause the at least one processor to:
detect receipt of, from a mobile device, a control command to access data acquired by a particular component that is located at the residence and that is communicatively coupled to the television receiver; and
initiate transfer of, to the mobile device, particular data acquired by the particular component in response to the control command.

17. A method for activating a home occupancy simulation, comprising:
receiving, by a television receiver, a command to activate the home occupancy simulation, to control timing of activation and deactivation of at least one component that is located at a residence and that is communicatively coupled to the television receiver, from a mobile device over a network connection based upon user-selection of a particular control object of a mobile application installed to the mobile device;
selecting, by the television receiver, a particular home occupancy simulation based upon a setting that identifies the particular home automation simulation from among a plurality of home occupancy simulations;
activating, by the television receiver, the particular home occupancy simulation to control timing of activation and deactivation of the at least one component that is located at the residence and that is communicatively coupled to the television receiver;
identifying another setting that specifies a particular degree of randomness to be injected into the timing of activation and deactivation of the at least one component; and
injecting, based on the another setting, the particular degree of randomness into the timing of activation and deactivation of the at least one component.

18. The method of claim 17, further comprising:
selecting the particular home occupancy simulation based on the setting that identifies the particular home occupancy simulation as one that includes instructions to control timing of activation and deactivation of the at least one component based upon end-user activation and deactivation of the at least one component.

19. The method of claim 17, further comprising:
selecting the particular home occupancy simulation based on the setting that identifies the particular home occupancy simulation as one that includes instructions to control timing of activation and deactivation of the at least one component based upon manual user-input.

20. The method of claim 17, further comprising:
selecting the particular home occupancy simulation based on the setting that identifies the particular home occupancy simulation as one that includes instructions to control timing of activation and deactivation of the at least one component based upon instructions downloaded prior to activation of the particular home occupancy simulation by the television receiver from a computing system over a network connection.
